(19) United States
(12) Patent Application Publication
(10) Pub. No.: US 2024/0097441 A1
(43) Pub. Date: Mar. 21, 2024

(54) MANAGEMENT SYSTEM, MANAGEMENT DEVICE, AND POWER BALANCING METHOD

(71) Applicants: TOYOTA JIDOSHA KABUSHIKI KAISHA, Toyota-shi (JP); CHUBU ELECTRIC POWER MIRAIZ CO., INC., Nagoya (JP); CHUBU ELECTRIC POWER CO., INC., Nagoya (JP)

(72) Inventors: Yusuke HORII, Nagoya-shi (JP); Eiko Megan UCHIDA, Obu-shi (JP); Masashi TANAKA, Nagakute-shi (JP); Masato EHARA, Gotemba-shi (JP); Sachio TOYORA, Gotemba-shi (JP); Tomoya TAKAHASHI, Ebina-shi (JP); Akinori MORISHIMA, Naka-gun (JP); Takuji MATSUBARA, Nagoya-shi (JP); Tohru NAKAMURA, Toyota-shi (JP); Ryou TAKAHASHI, Nagoya-shi (JP); Kenta ITO, Nagoya-shi (JP); Toshiki SUZUKI, Nagoya-shi (JP); Atsushi MIYASHITA, Nagoya-shi (JP); Takashi OCHIAI, Nagoya-shi (JP)

(73) Assignees: TOYOTA JIDOSHA KABUSHIKI KAISHA, Toyota-shi (JP); CHUBU ELECTRIC POWER MIRAIZ CO., INC., Nagoya (JP); CHUBU ELECTRIC POWER CO., INC., Nagoya (JP)

(21) Appl. No.: 18/229,874

(22) Filed: Aug. 3, 2023

(30) Foreign Application Priority Data
Sep. 16, 2022 (JP) 2022-148082

(51) Int. Cl. H02J 3/00

(52) U.S. Cl. CPC H02J 3/00

(57) ABSTRACT

A management system includes a plurality of resources configured to be electrically connected to an external power supply, and a management device configured to manage the resources. The management device includes a planning unit and a management unit. The planning unit is configured to determine a power balancing plan of each of the resources by using first information on a use schedule of each of the resources and second information indicating a magnitude of an environmental load in a process of generating electric power to be supplied by the external power supply. The management unit is configured to manage the resources to cause each of the resources to operate according to the power balancing plan or a modified power balancing plan in power balancing of the external power supply.

### CROSS-REFERENCE TO RELATED APPLICATION

This application claims priority to Japanese Patent Application No. 2022-148082 filed on Sep. 16, 2022, incorporated herein by reference in its entirety.

### BACKGROUND

### 1. Technical Field

The present disclosure relates to a management system, a management device, and a power balancing method.

### 2. Description of Related Art

For example, Japanese Unexamined Patent Application Publication No. 2007-185083 (JP 2007-185083 A) discloses a technology for determining whether to permit charging of a battery of an electrified vehicle with electric power supplied from an external power supply (more specifically, a commercial power supply) by using environmental information indicating the magnitude of an environmental load in the process of generating electric power to be supplied from the external power supply. In JP 2007-185083 A, information indicating the amount of carbon dioxide emitted to generate electric power is adopted as the environmental information. Since the global warming is accelerated as the amount of emitted carbon dioxide (CO₂) increases, the environmental load (load on natural environment) increases.

### SUMMARY

In the technology described in JP 2007-185083 A, the charging of the electrified vehicle is permitted when the amount of carbon dioxide along with power generation is below a preset threshold value. In this technology, however, the electrified vehicle can be charged by using the external power supply only when the external power supply supplies electric power with a small environmental load. When the charging of the electrified vehicle by the external power supply is prohibited even though a user plans to use the electrified vehicle, the user's convenience may be impaired. In JP 2007-185083 A, sufficient research has not been conducted into the use of the electrified vehicle for power balancing of the external power supply. An electrified vehicle including a power storage device can operate as a balancing power for the external power supply (e.g., a balancing power for leveling the power supply and demand) by charging or discharging the power storage device for the external power supply.

In the present disclosure, power balancing of an external power supply is appropriately performed by using resources while securing sufficient convenience for users of the resources and reducing an environmental load along with power supply.

A management system according to a first aspect of the present disclosure includes a plurality of resources configured to be electrically connected to an external power supply, and a management device configured to manage the resources. The management device includes a planning unit and a management unit. The planning unit is configured to determine a power balancing plan of each of the resources by using first information on a use schedule of each of the resources and second information indicating a magnitude of an environmental load in a process of generating electric power to be supplied by the external power supply. The management unit is configured to manage the resources to cause each of the resources to operate according to the power balancing plan or a modified power balancing plan in power balancing of the external power supply.

The management device described above can determine the power balancing plan in consideration of both the use schedule of each resource and the magnitude of the environmental load. The magnitude of the environmental load in the process of generating electric power to be supplied by the external power supply (hereinafter also simply referred to as “environmental load of electric power”) may vary depending on time slots. The environmental load of electric power corresponds to the environmental load along with the power supply. When the power balancing plan is determined according to the use schedule of each resource, electric power may be supplied from the external power supply during a time slot in which the environmental load of electric power is large depending on the resource. In the management system described above, the power balancing of the external power supply is performed by using the resource group (plurality of resources). Therefore, it is possible to reduce the overall environmental load of electric power received by the entire resource group by determining the power balancing plans of the resources to complement each other. Specifically, even if some resources receive electric power supplied from the external power supply during the time slot in which the environmental load of electric power is large, other resources receive electric power from the external power supply during a time slot in which the environmental load of electric power is small or supply electric power to the external power supply during the time slot in which the environmental load of electric power is large. Therefore, it is possible to reduce the overall environmental load of electric power received by the entire resource group. As described above, according to the above configuration, the power balancing of the external power supply can appropriately be performed by using the resources while securing sufficient convenience for the users of the resources and reducing the environmental load along with the power supply.

The resource may be an automobile, a vehicle other than the automobile (railroad vehicle, ship, airplane, etc.), an unmanned moving object, electric appliances (lighting device, air conditioner, etc.), or a stationary power storage system. The resource may include a power storage device. The resource may include at least one of an inverter that performs alternating current (AC) to direct current (DC) conversion and a DC-DC converter that performs DC-DC conversion. The management device may manage a plurality of types of resource.

The external power supply may be a commercial power supply of a retail electric power company or a power grid (e.g., a microgrid or a large-scale power grid arranged as an infrastructure). The external power supply may supply AC power or DC power.

The power balancing of the external power supply may be adjustment of supply and demand balance of the external power supply or frequency control on the external power supply. The resource may promote the power demand of the external power supply by storing or consuming electric power supplied from the external power supply. The resource may curtail the power demand of the external power supply by reducing the electric energy received from the external power supply (e.g., charge amount or consumption amount). The resource may increase the power supply amount of the external power supply by supplying electric power to the external power supply (reverse power flow).

The power balancing plan may be a daily plan. One day may be segmented into a plurality of time slots. The power balancing plan may indicate a consumption amount or a charge amount of electric power from the external power supply or a discharge amount of electric power to the external power supply for each of the time slots that segment one day. The first information may indicate a scheduled use start time of the resource. The first information may indicate a scheduled use end time of the resource in addition to the scheduled use start time of the resource. The second information may indicate the magnitude of the environmental load of electric power for each of the time slots that segment one day. The planning unit of the management device may determine the power balancing plan of each of the resources so that the resource is ready for use at the scheduled use start time of the resource.

The resources managed by the management device may include a plurality of vehicles. Each of the vehicles may include a power storage device and a charge control device configured to execute charge control on the power storage device. The power balancing plan may be a charge plan of the power storage device. The charge control device of the vehicle may be configured to set a scheduled use start time of the vehicle and a target state of charge (target SOC) of the power storage device in the charge control. The first information may indicate the scheduled use start time and the target SOC set in the charge control device.

According to the above configuration, it becomes easier to secure sufficient convenience for a vehicle user. Specifically, it becomes easier to store a sufficient amount of electric power (e.g., electric power equal to or higher than the target SOC) in the power storage device of the vehicle at the scheduled use start time of the vehicle. This reduces the occurrence of a case where the vehicle runs out of electric power while the user is using the vehicle. The scheduled use start time of the vehicle may be a scheduled departure time of the vehicle. The charge plan may indicate transition of the state of charge (SOC) or charge power of the power storage device. The SOC indicates the remaining power storage amount, and represents, for example, the ratio of the current power storage amount to the power storage amount in a fully charged state from 0% to 100%.

The second information may indicate, for each time slot, an amount of carbon dioxide emitted in the process of generating the electric power to be supplied by the external power supply. The planning unit may be configured to determine the charge plan of each of the vehicles to satisfy a condition that an SOC of the power storage device in each of the vehicles is equal to or higher than the target SOC at the scheduled use start time (hereinafter also referred to as “user requirement”), and a condition that a total value of the amounts of carbon dioxide emitted in the process of generating the electric power to be used in the charge plan of each of the vehicles is equal to or smaller than a predetermined target level (hereinafter also referred to as “environmental requirement”).

According to the above configuration, the charge plan of each vehicle is determined to satisfy both the user requirement and the environmental requirement. Thus, it becomes easier to secure sufficient convenience for the vehicle user and reduce the environmental load along with the power supply. The second information may indicate a CO₂ emission coefficient of the external power supply for each time slot.

Any of the management systems described above may further include a request device configured to request the management device to perform the power balancing of the external power supply. The external power supply may be a power system configured to supply electric power to a predetermined area. A charging location of each of the vehicles in the predetermined area may be registered in the management device. The management device may be configured to receive, from the request device, the second information and a request signal indicating details of the power balancing for each time slot. The management device may be configured to receive the scheduled use start time and the target SOC set in the charge control device from the vehicle or a mobile terminal carried by a user of the vehicle. The planning unit may be configured to determine the charge plan of each of the vehicles to achieve a state in which a total charge energy of the power storage devices of the vehicles increases during a time slot in which the request signal requests an increase in power demand, and a state in which the total charge energy of the power storage devices of the vehicles decreases during a time slot in which the request signal requests a decrease in the power demand.

The power demand of the external power supply is promoted as the total charge energy of the power storage devices of the vehicles using the electric power supplied from the external power supply increases. The power demand of the external power supply is curtailed as the total charge energy of the power storage devices of the vehicles using the electric power supplied from the external power supply decreases. According to the above configuration, the power balancing of the external power supply requested by the request signal can easily be performed appropriately according to the charge plan of each vehicle. The mobile terminal may be a smartphone, a laptop, a tablet terminal, a portable game console, a wearable device, or an electronic key.

In any of the management systems described above, the management device may further include a modification unit configured to, in response to a request from the request device, modify the charge plan of each of the vehicles determined by the planning unit. The management unit may be configured to cause the vehicle with the charge plan unmodified to operate according to the charge plan determined by the planning unit. The management unit may be configured to cause the vehicle with the charge plan modified by the modification unit to operate according to the modified charge plan.

According to the above configuration, the management device can easily perform the power balancing of the external power supply in response to the request from the request device.

In any of the managements system described above, the planning unit may be configured to, by using the second information indicating, for each time slot, the amount of carbon dioxide emitted in the process of generating the electric power to be supplied by the external power supply, determine the charge plan of each of the vehicles to satisfy a condition that the SOC of the power storage device in each of the vehicles is equal to or higher than the target SOC at the scheduled use start time, and to minimize the total value of the amounts of carbon dioxide emitted in the process of generating the electric power to be used in the charge plan of each of the vehicles.

According to the above configuration, the charge plan of each vehicle is determined to satisfy the user requirement and to minimize the amount of carbon dioxide emitted in the process of generating the electric power to be used in the charge plan. Thus, it becomes easier to secure sufficient convenience for the vehicle user and reduce the environmental load along with the power supply.

The charge control device may be configured to set a charge mode in response to an input from a user among a plurality of types of charge mode. The plurality of types of charge mode may include a first charge mode. The management unit may be configured not to execute charge control for the power balancing of the external power supply on the vehicle for which the first charge mode is set in the charge control device. The management unit may be configured to select a control target from among the vehicles for which a charge mode other than the first charge mode is set in the charge control device, and cause the selected control target to execute the charge control for the power balancing of the external power supply by transmitting a control command according to the charge plan or a modified charge plan to the control target.

According to the above configuration, the user can choose whether to permit the control of the management device (in a more specific example, remote control for the power balancing of the external power supply). This improves the convenience for the user. The charge control device for which the first charge mode is set may be configured to execute the charge control on the power storage device according to a charge schedule based on the scheduled use start time and the target SOC set in the charge control device by the user.

The management device may further include a prediction unit configured to execute movement prediction on each of the vehicles. The plurality of types of charge mode may further include a second charge mode and a third charge mode. The planning unit may be configured to, for the vehicle for which the second charge mode is set in the charge control device, determine the charge plan of the vehicle by using the second information and the scheduled use start time and the target SOC set in the charge control device by the user. The planning unit may be configured to, for the vehicle for which the third charge mode is set in the charge control device, set the scheduled use start time and the target SOC in the charge control device by using a result of the movement prediction, and determine the charge plan of the vehicle by using the set scheduled use start time, the set target SOC, and the second information.

According to the above configuration, the user can choose whether to cause the management device to make settings on the use schedule of the vehicle (settings of the scheduled use start time and the target SOC). Specifically, for the vehicle in the third charge mode, the planning unit of the management device sets the scheduled use start time and the target SOC appropriate for the vehicle by using the result of the movement prediction by the prediction unit. The convenience for the user is improved by automatic settings on the use schedule of the vehicle. Depending on the situation of the vehicle, the accuracy of the movement prediction by the prediction unit may decrease. In such a situation, the user can select the second charge mode to set the scheduled use start time and the target SOC by himself/herself. The user can select a desired charge mode depending on the situation.

The management unit may be configured to select a control target from among the vehicles, and set the charge plan or a modified charge plan in the charge control device of the selected control target. The charge control device may be configured to execute the charge control on the power storage device according to the set charge plan.

According to the above configuration, the control for the power balancing of the external power supply is executed by local control on the vehicle side (charge control device). According to the above configuration, the power balancing of the external power supply can easily be performed appropriately according to the power balancing plan set in the charge control device of each vehicle.

A management device according to a second aspect of the present disclosure is configured to manage a plurality of resources configured to be electrically connected to an external power supply. The management device includes a planning unit and a management unit. The planning unit is configured to determine a power balancing plan of each of the resources by using first information on a use schedule of each of the resources and second information indicating a magnitude of an environmental load in a process of generating electric power to be supplied by the external power supply. The management unit is configured to manage the resources to cause each of the resources to operate according to the power balancing plan or a modified power balancing plan in power balancing of the external power supply.

According to the management device described above, the power balancing of the external power supply can appropriately be performed by using the resources while securing sufficient convenience for the users of the resources and reducing the environmental load along with the power supply as in the management system described above.

A management device according to a third aspect of the present disclosure is configured to manage a plurality of resources configured to be electrically connected to an external power supply. The management device includes a determination unit and a transmission unit. The determination unit is configured to determine, for each time slot, a total electric energy to be balanced for the external power supply by the resources by using first information on a use schedule of each of the resources and second information indicating a magnitude of an environmental load in a process of generating electric power to be supplied by the external power supply. The transmission unit is configured to transmit the total electric energy for the each time slot that has been determined by the determination unit.

The information indicating, for each time slot, the total electric energy that can be balanced for the external power supply by the resources (hereinafter also referred to as “balancing information”) indicates a limit value of the power balancing amount. According to the above configuration, the management device can acquire the balancing information indicating the limit value of the power balancing amount at which sufficient convenience can be secured for the users of the resources and the environmental load along with the power supply can be reduced. The transmission unit may transmit the balancing information to the request device. Based on the balancing information, the request device can appropriately perform the power balancing of the external power supply by using the resources while securing sufficient convenience for the users of the resources and reducing the environmental load along with the power supply.

A power balancing method according to a fourth aspect of the present disclosure includes determining, by a management device configured to manage a plurality of resources configured to be electrically connected to an external power supply, a power balancing plan of each of the resources by using first information on a use schedule of each of the resources and second information indicating a magnitude of an environmental load in a process of generating electric power to be supplied by the external power supply, and operating, by each of the resources, according to the power balancing plan or a modified power balancing plan in power balancing of the external power supply.

According to the power balancing method described above, the power balancing of the external power supply can appropriately be performed by using the resources while securing sufficient convenience for the users of the resources and reducing the environmental load along with the power supply as in the management system described above.

According to the present disclosure, the power balancing of the external power supply can appropriately be performed by using the resources while securing sufficient convenience for the users of the resources and reducing the environmental load along with the power supply.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 shows a schematic configuration of a management system according to an embodiment of the present disclosure;

FIG. 2 shows the configurations of a vehicle and an outlet device shown in FIG. 1;

FIG. 3 illustrates a method for a retail electric power company to procure electric power in the embodiment of the present disclosure;

FIG. 4 illustrates a power balancing method according to the embodiment of the present disclosure;

FIG. 5 shows a first example of information on electric power to be procured by the retail electric power company in the embodiment of the present disclosure;

FIG. 6 shows a second example of the information on electric power to be procured by the retail electric power company in the embodiment of the present disclosure;

FIG. 7 shows a charge mode setting screen to be displayed by a user terminal (mobile terminal) shown in FIG. 1;

FIG. 8 illustrates three types of charge mode that can be set for the vehicle shown in FIG. 1;

FIG. 9 illustrates a smart charge plan and a possible demand response (DR) amount in the embodiment of the present disclosure;

FIG. 10 illustrates a process related to power balancing of an external power supply to be executed by a management device according to the embodiment of the present disclosure;

FIG. 11 shows an example of a screen on which the user terminal (mobile terminal) shown in FIG. 1 displays DR records; and

FIG. 12 shows a modification of an environmental index shown in FIG. 6.

### DETAILED DESCRIPTION OF EMBODIMENTS

An embodiment of the present disclosure will be described in detail with reference to the drawings. In the drawings, the same or corresponding parts are denoted by the same reference signs and the description thereof will not be repeated.

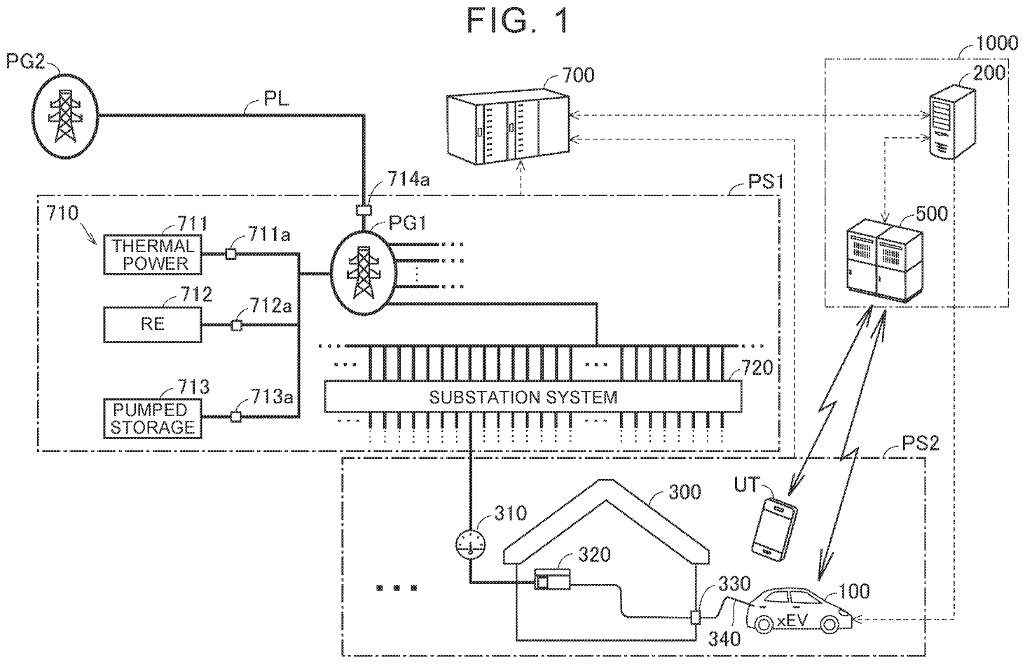

FIG. 1 shows a schematic configuration of a management system according to the embodiment of the present disclosure. Referring to FIG. 1, the management system according to the present embodiment includes a server 700 and a management device 1000. The management device 1000 includes servers 200, 500.

Each of the servers 200, 500, 700 is, for example, a computer including a human-machine interface (HMI) and a communication interface (I/F). Each computer includes a processor and a storage device. The processor may be a central processing unit (CPU). The storage device stores, in addition to programs to be executed by the processor, information to be used in the programs (e.g., maps, mathematical formulas, and various parameters). The HMI includes an input device and a display device. The HMI may be a touch panel display.

A power system PS1 includes a power grid PG1, a power generation system 710, and a substation system 720. The power system PS1 supplies electric power to a predetermined area PS2. In the present embodiment, an electric power company corresponds to a transmission system operator (TSO) of the power system PS1. The power system PS1 supplies alternating current (AC) power (e.g., single-phase or three-phase AC power). The power system PS1 according to the present embodiment is an example of an “external power supply” according to the present disclosure.

The power grid PG1 is constructed by a power transmission and distribution facility. The power generation system 710, the substation system 720, and a power grid PG2 are connected to the power grid PG1. The power grid PG2 supplies electric power to an area (not shown) different from the area PS2. The power grid PG1 (power system PS1) and the power grid PG2 have different TSOs. The power grid PG1 is connected to the power grid PG2 via an interconnection line PL. Electric power is interchanged between the power grid PG1 and the power grid PG2. The power grid PG1 is supplied with electric power from the power generation system 710.

The power generation system 710 includes a thermal power plant 711, a renewable energy (RE) power plant 712, and a pumped storage power plant 713. The thermal power plant 711 generates electric power by using thermal power (coal thermal power, LNG thermal power, oil thermal power, etc.). The LNG means liquefied natural gas. Thermal power generation tends to emit more carbon dioxide (CO₂) along with the power generation than other power generation methods. The RE power plant 712 generates electric power by using renewable energy. The RE power plant 712 may include at least one of a solar power plant, a wind power plant (e.g., an onshore wind power plant or an offshore wind power plant), a hydroelectric power plant, a geothermal power plant, and a biomass power plant. In the present embodiment, the RE power plant 712 includes a solar power plant, a wind power plant, and a hydroelectric power plant. The pumped storage power plant 713 stores energy by pumping water with surplus electric power (pumping power) when the electric power of the power grid PG1 is surplus, and performs pumped storage power generation by using the stored potential energy (hydropower) when the electric power of the power grid PG1 is insufficient.

The power system PS1 includes detectors 711a, 712a that acquire information (e.g., voltage, current, and electric energy) on electric power supplied to the power grid PG1 from the thermal power plant 711 and the RE power plant 712, respectively. The power system PS1 further includes detectors 713a, 714a that acquire information (e.g., voltage, current, and electric energy) on electric power exchanged between the power grid PG1 and the pumped storage power plant 713 and between the power grid PG1 and the power grid PG2, respectively. The detectors are provided to the individual power plants. Although only one detector 712a is shown for the RE power plant 712 in FIG. 1, the detector 712a is provided for each of the solar power plant, the wind power plant, and the hydroelectric power plant included in the RE power plant 712. Detection results from the detectors are output to the server 700. The power supply configuration of the power generation system 710 is not limited to the configuration shown in FIG. 1, and can be changed as appropriate. The power generation system 710 may further include other power plants (e.g., a nuclear power plant).

The power grid PG1 supplies electric power to the area PS2 via the substation system 720. The substation system 720 includes various types of substation equipment for converting electric power generated by the power generation system 710 into electric power suitable for consumers. The substation system 720 may include a primary substation, a distribution substation, and a pole transformer. An under-frequency relay (UFR) may be installed for each substation feeder.

The area PS2 includes a residence 300. The residence 300 corresponds to a home of a user of a vehicle 100. The residence 300 includes a distribution board 320. The distribution board 320 receives electric power supplied from the power system PS1, and supplies the electric power to each of a plurality of outlets (not shown) installed indoors and an outlet device 330 that outputs the electric power outdoors. The residence 300 includes various household electric appliances (e.g., lighting devices, air conditioners, heaters, cooking appliances, information devices, television sets, refrigerators, and washing machines) that receive electric power supplied from the indoor outlets. The user can electrically connect the vehicle 100 and the outlet device 330 by using a charging cable 340. Although details will be described later, the outlet device 330 supplies electric power to the vehicle 100 via the charging cable 340.

A smart meter 310 is installed between the power system PS1 and the distribution board 320. The electric energy supplied from the power system PS1 to the residence 300 is measured by the smart meter 310 installed at a power receiving point. The server 700 sequentially receives measurement values from the smart meter 310 at predetermined intervals (e.g., every 30 minutes). The residence 300 may further include at least one of a variable natural power supply (e.g., a solar panel installed on a roof), a cogeneration system (e.g., a heat pump water heater), and a home energy management system (HEMS). The residence 300 may be configured to supply electric power to the power system PS1 (reverse power flow).

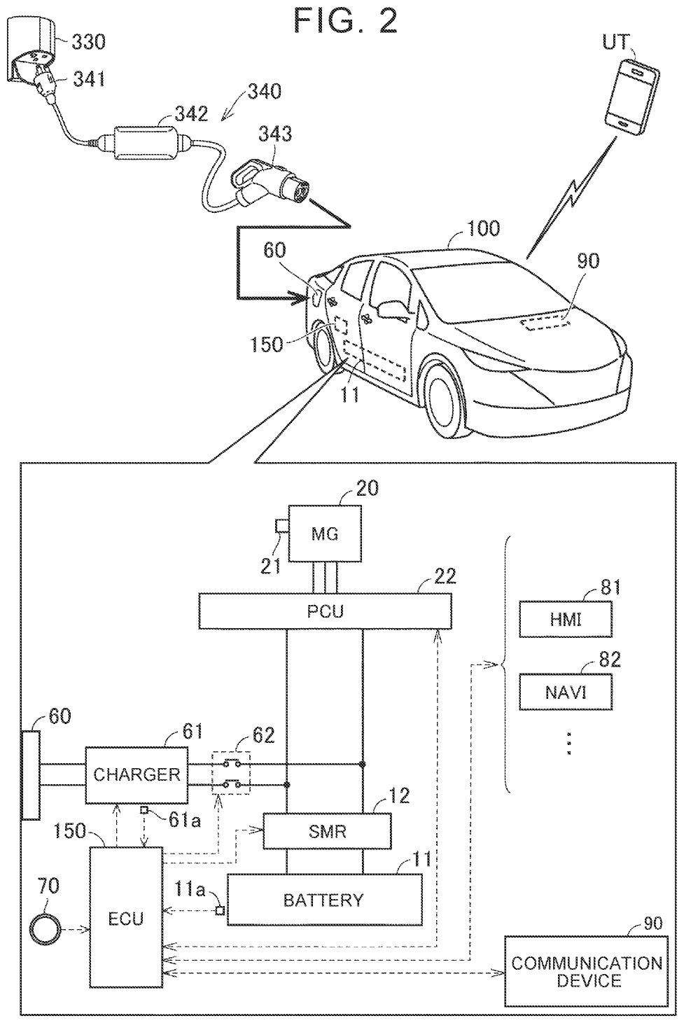

FIG. 2 shows the configurations of the vehicle 100 and the outlet device 330. Referring to FIG. 2, the vehicle 100 includes a battery 11, a system main relay (SMR) 12, a motor generator (MG) 20, a power control unit (PCU) 22, an inlet 60, a charger 61, a charging relay 62, a start switch 70, an HMI 81, a navigation system (hereinafter also referred to as “NAVI”) 82, a communication device 90, and an electronic control unit (ECU) 150. The SMR 12, the PCU 22, the inlet 60, the charger 61, and the charging relay 62 are controlled by the ECU 150.

The ECU 150 is a computer including a processor and a storage device. The storage device stores, in addition to programs to be executed by the processor, information to be used in the programs (e.g., maps, mathematical formulas, and various parameters). In the present embodiment, various types of vehicle control in the ECU 150 (e.g., charge control and discharge control for the battery 11) are executed by the processor executing the programs stored in the storage device. Detection results from various sensors mounted on the vehicle 100 are output to the ECU 150.

The battery 11 stores electric power for traveling of the vehicle 100. The vehicle 100 is configured to travel by using the electric power stored in the battery 11. The vehicle 100 further includes a sensor module 11a that monitors the state of the battery 11 (e.g., voltage, current, and temperature). The sensor module 11a may be a battery management system (BMS). The ECU 150 can acquire the state of the battery 11 (e.g., temperature, current, voltage, SOC, and internal resistance) based on the output of the sensor module 11a. The vehicle 100 according to the present embodiment is a battery electric vehicle (BEV) without an engine (internal combustion engine). The battery 11 can be various power storage devices for vehicles (e.g., liquid secondary battery, all-solid-state secondary battery, or assembled battery). Examples of the secondary battery for vehicles include a lithium-ion battery and a nickel metal hydride battery. The battery 11 according to the present embodiment is an example of a “power storage device” according to the present disclosure.

The outlet device 330 receives electric power supplied from the power system PS1 and supplies the electric power. The outlet device 330 may output AC power having a voltage of 100 V or 200 V. The charger 61 charges the battery 11 with electric power input to the inlet 60 from the outlet device 330 through the charging cable 340. The charger 61 includes a power conversion circuit. In the present embodiment, the outlet device 330 does not include an alternating current-to-direct current (AC-DC) conversion circuit, and the charger 61 (on-board charger) includes the AC-DC conversion circuit (inverter). The charging relay 62 switches connection and disconnection of an electric power path from the inlet 60 to the battery 11. The vehicle 100 further includes a sensor module 61a that monitors the state of the charger 61 (e.g., current, voltage, and temperature). The charger 61 and the charging relay 62 are positioned between the inlet 60 and the battery 11. In the present embodiment, a charging line including the inlet 60, the charger 61, and the charging relay 62 is connected between the SMR 12 and the PCU 22. However, the present disclosure is not limited to this, and the charging line may be connected between the battery 11 and the SMR 12.

The charging cable 340 includes a plug 341, a control box 342, and a connector 343, and includes a communication line and a power line inside. The outlet device 330 includes an outlet to and from which the plug 341 is attachable and detachable. The plug 341 is connected to the outlet of the outlet device 330 and receives AC power from this outlet. The AC power output from the outlet device 330 to the plug 341 (input end) is output to the connector 343 (output end) through the control box 342.

The vehicle 100 includes the inlet 60 to and from which the connector 343 is attachable and detachable. When the plug 341 is inserted into the outlet of the outlet device 330 and the connector 343 is connected to the inlet 60 of the parked vehicle 100, the vehicle 100 is electrically connected to the power system PS1 via the outlet device 330 (hereinafter also referred to as “plugged-in state”). The vehicle 100 is not electrically connected to the power system PS1, for example, while the vehicle 100 is traveling (hereinafter also referred to as “plugged-out state”). The vehicle 100 may include a plurality of inlets so as to be compatible with a plurality of types of power supply methods (e.g., AC and DC methods).

The control box 342 of the charging cable 340 includes a control device and a power conversion circuit (neither shown). The control device communicates with the vehicle 100 via the communication line inside the cable. The control device does not communicate with the servers 200, 500, 700. The AC power adjusted to an appropriate voltage and current by the power conversion circuit in the control box 342 is output from the connector 343. In the plugged-in state, the control device controls the power conversion circuit based on a command from the vehicle 100 and outputs supply power (e.g., AC power) to the connector 343.

The vehicle 100 is configured to execute external charge. That is, the vehicle 100 is configured to charge the battery 11 with electric power from the outside of the vehicle. The vehicle 100 in the plugged-in state can execute power balancing of the power system PS1 by the external charge. For example, electric power for the external charge is supplied from the power system PS1 to the inlet 60 through the outlet device 330 and the charging cable 340. The charger 61 converts the electric power received by the inlet 60 (e.g., AC power) into DC power suitable for charging the battery 11, and outputs the converted DC power to the battery 11.

The PCU 22 drives the MG 20 by using the electric power supplied from the battery 11. The PCU 22 includes, for example, an inverter and a DC-DC converter. The MG 20 functions as a traveling motor of the vehicle 100. The MG 20 is, for example, a three-phase AC motor generator. The MG 20 is driven by the PCU 22 and rotates drive wheels of the vehicle 100. The MG 20 generates regenerative power and supplies the generated regenerative power to the battery 11. The vehicle 100 further includes a motor sensor 21 that monitors the state of the MG 20 (e.g., current, voltage, and temperature). The vehicle 100 may include any number of traveling motors. The vehicle 100 may include one, two, three, or more traveling motors. The traveling motor may be an in-wheel motor.

The SMR 12 switches connection and disconnection of an electric power path from the battery 11 to the PCU 22. When the vehicle 100 is traveling, the SMR 12 is closed (connected) and the charging relay 62 is open (disconnected). When electric power is exchanged between the battery 11 and the inlet 60, both the SMR 12 and the charging relay 62 are closed (connected).

The HMI 81 includes an input device and a display device. The HMI 81 may include a touch panel display. The HMI 81 may include at least one of a meter panel and a head-up display. The HMI 81 may include a smart speaker that receives voice input.

The NAVI 82 includes a touch panel display, a global positioning system (GPS) sensor, a processor, and a storage device (none of which are shown). The storage device stores map information. The touch panel display receives an input from the user and displays a map and other information. The NAVI 82 is configured to detect the position of the vehicle 100 by using the GPS sensor and display the position of the vehicle 100 in real time on the map. The NAVI 82 executes a route search for finding an optimal route (e.g., shortest route) from a current position of the vehicle 100 to a destination by referring to the map information. The NAVI 82 may update the map information over the air (OTA) as needed.

The communication device 90 includes various communication I/Fs. The ECU 150 communicates with devices outside the vehicle 100 through the communication device 90. The communication device 90 includes a wireless communication device for communication with each of the servers 200, 500. The communication device 90 communicates with each of the servers 200, 500 via a communication network (e.g., a wide area network constructed by the Internet and wireless base stations). The wireless communication device is configured to access the communication network. The wireless communication device includes, for example, a data communication module (DCM). The wireless communication device may include a communication I/F compatible with the fifth or sixth generation mobile communication system (5G or 6G). The vehicle 100 wirelessly communicates with the server 500 in both the plugged-in state and the plugged-out state. The vehicle 100 wirelessly communicates with the server 500 even while traveling. The vehicle 100 wirelessly communicates with the server 200 in the plugged-in state. In the present embodiment, the vehicle 100 receives commands or notifications from the servers 200, 500 by the wireless communication device.

A mobile terminal UT is carried by the user of the vehicle 100. In the present embodiment, a smartphone including a touch panel display is adopted as the mobile terminal UT. The smartphone includes a built-in computer. The communication device 90 includes a communication I/F for direct communication with the mobile terminal UT located inside the vehicle or within a range around the vehicle. The communication device 90 and the mobile terminal UT may execute short-range communication such as wireless local area network (LAN), near field communication (NFC), or Bluetooth (registered trademark). The mobile terminal UT may be any mobile terminal such as a laptop, a tablet terminal, a wearable device (e.g., smart watch or smart glasses), or an electronic key. Any communication method can be used for communication between the vehicle 100 and the mobile terminal UT.

The mobile terminal UT is preregistered in the servers 200, 500 and is configured to wirelessly communicate with the servers 200, 500. Predetermined application software (hereinafter referred to as “mobile app”) is installed in the mobile terminal UT. The servers 200, 500 perform predetermined authentication before starting communication with mobile terminals, and communicate only with mobile terminals that have been successfully authenticated. This reduces the risk of unauthorized communication by mobile terminals not registered in the servers 200, 500. The user of the vehicle 100 can start communication with the servers 200, 500 by entering predetermined authentication information (information for successful authentication) to the mobile terminal UT. The entry of the predetermined authentication information can be skipped by preregistering the authentication information in the mobile app.

The mobile terminal UT can exchange information with the servers 200, 500 via the mobile app. In the present embodiment, the mobile terminal UT includes a position sensor. The position sensor may be a sensor using a GPS. The mobile terminal UT transmits information indicating the position of the user to the server 500 periodically or in response to a request from the server 500.

A vehicle system including the ECU 150 (system that controls the vehicle 100) is switched ON (operated) and OFF (stopped) by the user's operation on the start switch 70. For example, the start switch 70 is installed in a vehicle cabin of the vehicle 100. The vehicle system is started when the start switch 70 is turned ON. The vehicle system is stopped when the start switch 70 is turned OFF while the vehicle system is in operation. An operation of turning OFF the start switch 70 is prohibited while the vehicle 100 is traveling. The start switch of the vehicle is commonly referred to as “power switch” or “ignition switch”.

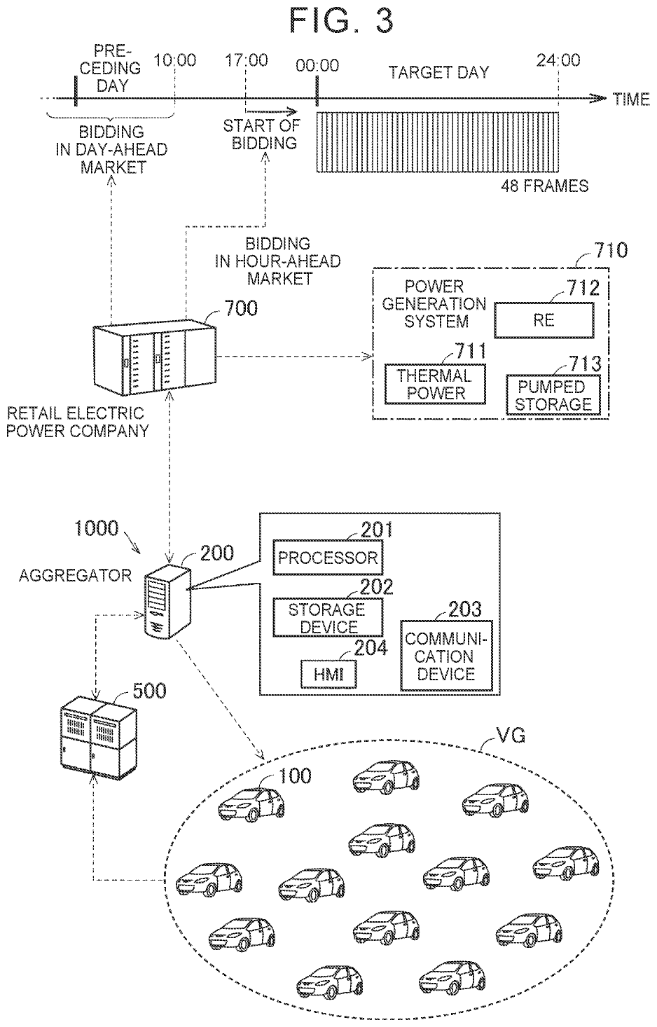

FIG. 3 illustrates a method for a retail electric power company to procure electric power. Referring to FIG. 3, the retail electric power company procures electric power from, for example, at least one of an electric power market, the power generation system 710, and predetermined distributed energy resources (DERs), and sells the procured electric power. The DERs include a vehicle group VG. The server 700 corresponds to a computer belonging to the retail electric power company. The server 700 is configured to procure electric power from each of the electric power market, the power generation system 710, and the vehicle group VG.

The server 700 (retail electric power company) may procure electric power in a spot market (day-ahead market) and an hour-ahead market (intraday market). The spot market and the hour-ahead market are opened and operated by a wholesale electric power exchange such as the Japan Electric Power Exchange (JEPX). In each market, electric power is traded as a product. Each product is bought and sold by, for example, bidding. In each market, the product is traded on a frame basis. The “frame” is one of frames of unit time into which one day is divided. In the wholesale electric power exchange, trading is carried out for 48 frames that segment one day in units of 30 minutes. Bidding in the spot market is closed at 10:00 on a day before the day including a target frame. The hour-ahead market opens at 17:00 on the day before the day including the target frame and closes one hour before the start time of the target frame.

The server 700 (retail electric power company) may procure electric power from the power generation system 710. For example, the server 700 may procure electric power from the power generation system 710 by directly controlling the power generation system 710. Alternatively, the server 700 may request power generation control on the power generation system 710 from another server (e.g., a server belonging to a power generation company that has a bilateral contract with the retail electric power company).

In the present embodiment, the server 700 (retail electric power company) procures electric power from predetermined DERs. The predetermined DERs include the vehicle group VG and may further include resources other than the vehicle group VG. When the server 700 procures electric power from the vehicle group VG, it requests the management device 1000 to control the vehicle group VG. The vehicle group VG includes a plurality of vehicles and is managed by the management device 1000 (servers 200 and 500). The server 200 includes a processor 201, a storage device 202, a communication device 203, and an HMI 204. In the present embodiment, the server 200 functions as a “planning unit”, a “management unit”, a “prediction unit”, a “determination unit”, a “transmission unit”, and a “modification unit” according to the present disclosure. In the present embodiment, the processor 201 executes a program stored in the storage device 202 to implement the above units. However, the present disclosure is not limited to this, and the above units may be implemented by hardware (electronic circuit) of the server 200.

The vehicle group VG includes the vehicle 100 (FIG. 2). In the present embodiment, each vehicle in the vehicle group VG is electrically connectable to the power system PS1 (FIG. 1), and includes a power storage device that can be charged with electric power supplied from the power system PS1 in the area PS2 (FIG. 1). Each vehicle in the vehicle group VG is an electrified vehicle (xEV) including a power storage device, and more specifically, a personally owned vehicle (POV). The number of vehicles in the vehicle group VG may be 10 or more and less than 100, 100 or more and less than 500, or 500 or more. The configurations of the vehicle 100 and the other vehicles in the vehicle group VG may be the same or different. Although illustration is omitted, users of the vehicles other than the vehicle 100 also carry mobile terminals similar to the mobile terminal UT. The mobile terminal carried by each vehicle user corresponds to a “user terminal” registered for each vehicle user.

The server 200 corresponds to a computer belonging to an aggregator. The aggregator is an electric power company that bundles a plurality of DERs to provide an energy management service. Each vehicle in the vehicle group VG can function as the DER. The server 200 may cause the DERs to function as virtual power plants (VPPs) by remotely and centrally controlling the DERs. The aggregator according to the present embodiment corresponds to an electrified vehicle charge controller. The server 500 may belong to the aggregator, or may belong to an automaker.

The server 200 may perform demand response (DR) for the DERs in order to centrally control the DERs as the VPPs. Power balancing of the power system PS1 is requested on the DERs by DR. The server 200 may use DR to cause the DERs to perform power balancing of the power system PS1 requested from the server 700 or power balancing of the power system PS1 successfully won on the electric power market.

By participating in DR (power balancing), the DERs can give flexibility and adequacy to the power system PS1. Administrators of the DERs participating in DR permit the server 200 to remotely control the DERs. The server 200 can cause the DERs to perform charging, power consuming, or discharging for power balancing of the power system PS1 by remote control. For example, the ECU 150 of the vehicle 100 controls the charger 61 in response to a command from the server 200 to perform power balancing of the power system PS1. Even when the server 200 transmits commands to the DERs, the DERs cannot perform power balancing by remote control if preparation of the DERs for power balancing is not completed. Therefore, the administrator of each DER participating in DR is required to complete the preparation of the DER before starting DR.

Any type of power balancing can be performed. Power balancing may be, for example, supply and demand balancing, power supply stabilization, load following, or frequency balancing. The DERs may act as balancing powers for the power system PS1 by remote control. The balancing power may be referred to as “reserve”.

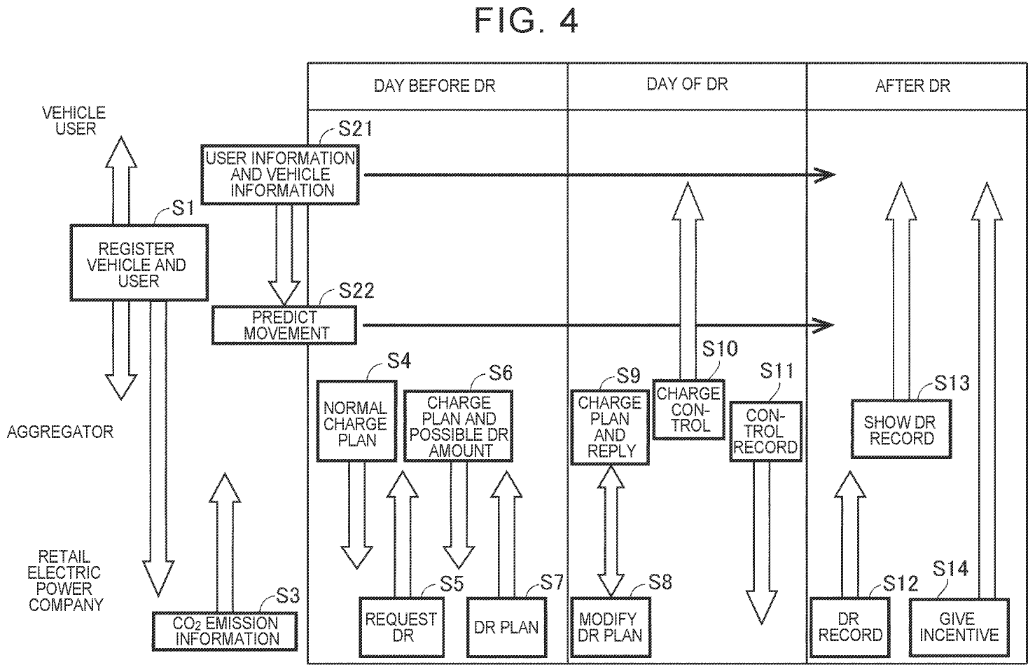

FIG. 4 illustrates processes to be executed by the management device 1000, the server 700, the vehicle, and the user terminal when DR is performed. Each step in FIG. 4 will simply be represented by “S”.

Referring to FIG. 4 together with FIGS. 1 to 3, each vehicle in the vehicle group VG and the user of each vehicle are registered in each of the servers 200, 500, 700 in S1. Unique vehicle identification information (vehicle ID) is assigned to each registered vehicle, and unique user identification information (user ID) is assigned to each registered user. The user ID also functions as identification information of the user terminal (e.g., the mobile terminal UT). The vehicle ID may be a vehicle identification number (VIN).

In the present embodiment, the user (manager) of each vehicle in the vehicle group VG concludes a contract with each of the aggregator and the retail electric power company in advance. The aggregator performs DR in response to a request from the retail electric power company. The retail electric power company gives a predetermined incentive to the vehicle user who has participated in DR. The registration (S1) may be performed at the time of contract.

In the present embodiment, the servers 200, 500, 700 use common identification information (vehicle ID and user ID) to identify the vehicle and its user. Each of the servers 200, 500, 700 holds information on each registered vehicle (hereinafter also referred to as “vehicle information”) and information on each registered user (hereinafter also referred to as “user information”). Each server holds, as the user information, identification information (vehicle ID) of the vehicle belonging to the user, an address of the user terminal, and information indicating an incentive acquired by the user. Each server holds, as the vehicle information, specifications of the vehicle (e.g., specifications related to charging) and a charging location (power supply point). The vehicle information and the user information are stored in the storage device of each server in association with the vehicle ID and the user ID, respectively. Therefore, each server can extract the vehicle information and the user information associated with the specified vehicle and user, respectively.

As described above, the charging location of each vehicle in the vehicle group VG is registered in each of the servers 200, 500, 700. The charging location is in the area PS2. The charging location of the vehicle 100 shown in FIG. 1 is the home of the vehicle user (residence 300). However, the present disclosure is not limited to this, and the charging location can be set to any location in the area PS2. For example, the charging location may be a workplace of the vehicle user. The charging location may be identified by coordinate values (latitude and longitude) or by identification information of a watt-hour meter (e.g., the smart meter 310 shown in FIG. 1) installed at the charging location. In addition to the charging location, a breaker capacity at the charging location (e.g., a breaker capacity of the distribution board 320 shown in FIG. 1) may be registered in each server.

In S21, each vehicle in the vehicle group VG and each user terminal belonging to the vehicle user transmit the vehicle information and the user information to the server 500. The server 500 periodically communicates with each vehicle and sequentially acquires the vehicle information from each vehicle. The server 500 periodically communicates with each user terminal and sequentially acquires the user information from each user terminal. Such vehicle information and user information are stored in the storage device of the server 500 and updated as needed.

The user information transmitted from each user terminal to the server 500 includes the user's position and data on the user's behavior. The data on the user's behavior is, for example, data in which the user's position and time are associated with the daily behavior of the user.

The vehicle information transmitted from each vehicle to the server 500 includes the position of the vehicle, the state of the power storage device (e.g., voltage, current, temperature, and SOC), the system connection state (plugged-in state or plugged-out state), the state of the vehicle system (ON or OFF), information set in the navigation system (e.g., a travel route to a destination), and data on vehicle movement (e.g., data in which the position of the vehicle and time are associated with daily vehicle movement).

In the present embodiment, the position of the vehicle 100 and the SOC of the battery 11 are transmitted from the vehicle 100 to the server 500 in real time as needed while the vehicle 100 is traveling. The latest system connection state is transmitted from the vehicle 100 to the server 500 when the vehicle 100 is switched between the plugged-in state and the plugged-out state. The latest state of the vehicle system is transmitted from the vehicle 100 to the server 500 when the vehicle system is switched between ON and OFF in the vehicle 100. When a destination is set in the NAVI 82, a travel route calculated by the NAVI 82 is transmitted from the vehicle 100 to the server 500.

The server 200 can acquire the vehicle information and the user information from the server 500. For example, the server 500 transmits the vehicle information and the user information to the server 200 periodically or in response to a request from the server 200.

In S22, the server 200 predicts movement of each vehicle in the vehicle group VG by using the vehicle information and the user information. The server 200 executes the prediction each time new information is received from the server 500. The server 200 improves prediction accuracy by executing the prediction based on the latest information.

The server 200 may acquire a travel plan of the vehicle from information set in the navigation system. Examples of the travel plan include a point of departure, departure time from the point of departure, a destination, arrival time at the destination, and a travel route to the destination. The server 200 can predict a movement schedule of the vehicle (future transition of the position of the vehicle) from the travel plan of the vehicle. The server 200 may estimate that the vehicle is parked when the vehicle system is switched from ON to OFF. The server 200 may estimate that the vehicle is present at the user's home or workplace when the vehicle remains parked for a predetermined period or longer. The server 200 may predict that the vehicle will start moving in a predetermined period when the vehicle system is switched from OFF to ON. The server 200 may predict the arrival time of the vehicle at the destination and the SOC upon the arrival while tracking the position of the vehicle by using position information and SOC information of the vehicle. The server 200 may predict the movement schedule of the vehicle from history data on the vehicle movement (e.g., weather information, traffic jam information, and past position data managed for each day of the week).

The server 200 may predict a behavior schedule of the user (future transition of the user's position) and predict the movement schedule of the vehicle from the predicted behavior schedule of the user. The server 200 may determine whether the user is in the vehicle based on the position information of the vehicle and the position information of the user. The server 200 may predict the user's future behavior while tracking the position of the user after the user gets out of the vehicle by using the position information of the user. The server 200 may predict the behavior schedule of the user from history data on the user's behavior (e.g., weather information, traffic jam information, and past position data managed for each day of the week).

In S3, the server 700 acquires CO₂ emission information related to the day on which DR will be performed, and transmits the acquired CO₂ emission information to the server 200. The process of S3 will be described below.

The server 700 first determines the day on which DR will be performed. The determined day will also be referred to as “target day”. The target day corresponds to the “day of DR”.

The server 700 may perform DR to achieve power balancing of the power system PS1 in each of the 48 frames that segment one day. The server 700 may determine whether an imbalance will occur in the power system PS1 in each of the 48 frames, and set the target day to a day on which the imbalance is predicted to occur in at least one frame. However, the present disclosure is not limited to this, and any method may be used for determining the target day (and the purpose of DR). The server 700 may perform DR in order to obtain profit in market trading, prevent power outage, or reduce an environmental load.

Next, the server 700 acquires the ratio of various power supplies (power supply configuration) for electric power scheduled to be procured on the target day (day on which DR will be performed). The types of power supply may be classified based on power generation methods. As described above, the retail electric power company procures electric power for the power system PS1, for example, from at least one of the electric power market, the power generation system 710, and the DERs (see FIG. 3). Electric power is procured for each predetermined time unit (frame). Therefore, the daily power supply configuration may differ for each time slot.

The server 700 calculates a CO₂ emission coefficient for each time slot based on the acquired power supply configuration for each time slot. The CO₂ emission coefficient indicates the amount of carbon dioxide emitted in the process of power generation that is converted in terms of unit electric energy. The generated electric energy is multiplied by the CO₂ emission coefficient to obtain the amount of carbon dioxide emitted in the process of power generation. The CO₂ emission information corresponds to information indicating the CO₂ emission coefficient for each time slot. In the present embodiment, the CO₂ emission information is an example of “second information” according to the present disclosure.

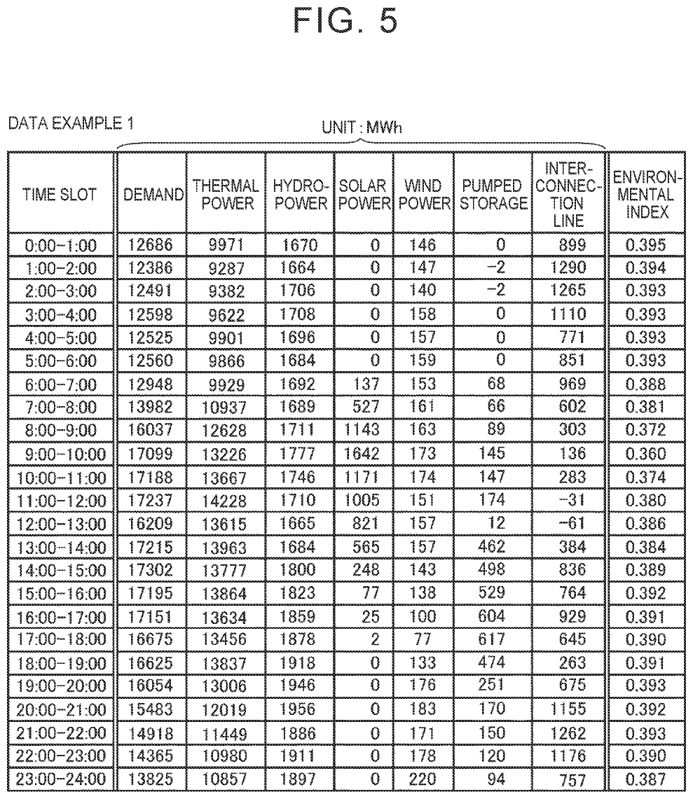

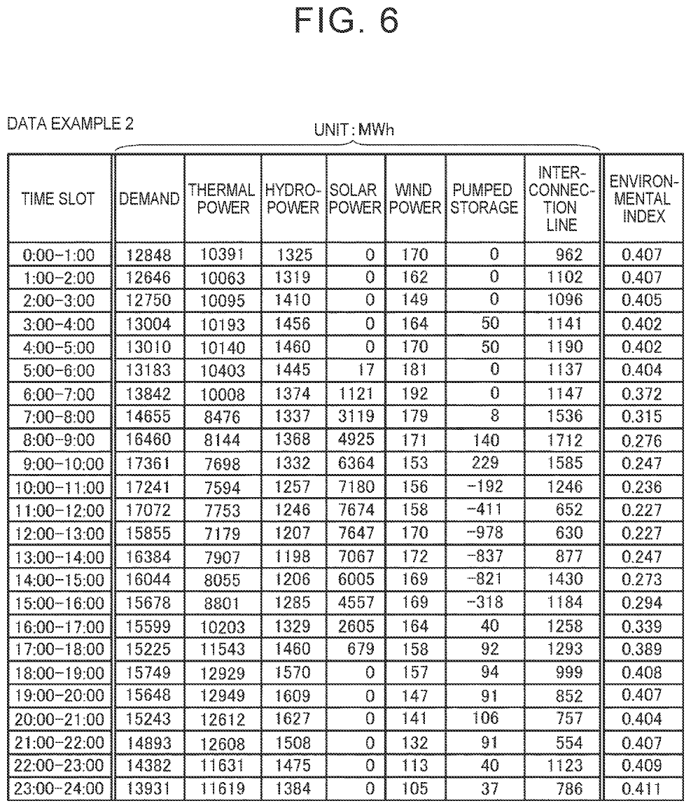

A specific example of the power supply configuration and the CO₂ emission information related to daily electric power to be procured by the retail electric power company (server 700) will be described below with reference to FIGS. 5 and 6. FIG. 5 shows a first example of information on electric power to be procured by the retail electric power company. FIG. 6 shows a second example of the information on electric power to be procured by the retail electric power company.

In FIGS. 5 and 6, “demand” indicates a demanded electric energy (MWh) of the power system PS1 for use in the area PS2 on the target day. The demanded electric energy may be the total value of electric energies to be used at charging locations registered in the servers 200, 500, 700. “Thermal power” indicates an electric energy (MWh) to be procured by the retail electric power company from the thermal power plant 711 on the target day. “Hydropower”, “solar power”, and “wind power” indicate electric energies (MWh) to be procured by the retail electric power company from the RE power plant 712 (hydroelectric power plant, solar power plant, and wind power plant) on the target day. “Pumped storage” indicates an electric energy (MWh) to be procured by the retail electric power company from the pumped storage power plant 713 (positive value) or to be stored in the pumped storage power plant 713 (negative value) on the target day. “Interconnection line” indicates an electric energy (MWh) to be procured by the retail electric power company from the power grid PG2 (positive value) or to be transmitted to the power grid PG2 (negative value) on the target day. Actual values of the electric energies are measured by watt-hour meters (including the smart meter 310) in the area PS2 and the detectors 711a to 714a shown in FIG. 1.

In the present embodiment, the server 700 predicts the electric energies on the demand, thermal power, hydropower, solar power, wind power, pumped storage, and interconnection line shown in FIGS. 5 and 6 on a day before the target day or earlier. The server 700 predicts the demanded electric energy for each time slot based on, for example, a past demand history (e.g., record data on the past demanded electric energy managed for each season, weather information, and time slot). The retail electric power company may perform power trading (purchase contract) to procure electric power from each of the power generation system 710 and the power grid PG2 on a day before the target day or earlier. The purchase contract may be concluded in the electric power market or may be a bilateral contract. The server 700 may predict the electric energies on the thermal power, pumped storage, and interconnection line for each time slot based on the result of power trading. The electric energy generated by the RE power plant 712 may vary depending on weather conditions. Therefore, the server 700 may predict the electric energies on the hydropower, solar power, and wind power for each time slot by using weather information (e.g., weather, cloud movement, and temperature). The server 700 may perform the prediction by using a trained model obtained by machine learning using artificial intelligence (AI).

In FIGS. 5 and 6, “environmental index” corresponds to the CO₂ emission coefficient (kg-CO₂/kWh). In the present embodiment, the power grid PG2 has a power supply configuration that mainly uses thermal power. Therefore, the thermal power plant 711 and the power grid PG2 are regarded as CO₂ emission sources among the various power supplies shown in FIGS. 5 and 6. The server 700 calculates the CO₂ emission coefficient for each time slot according to the formula “CO₂ emission coefficient=coefficient W×(thermal power+interconnection line)/total supply electric energy”. In the above formula, “thermal power+interconnection line” corresponds to the total electric energy to be supplied from the thermal power plant 711 and the power grid PG2. “Total supply electric energy” corresponds to the total electric energy to be supplied from all the power supplies (thermal power, hydropower, solar power, wind power, pumped storage, and interconnection line). The coefficient W indicates the amount of carbon dioxide to be emitted when a unit electric energy is generated by the CO₂ emission sources. The server 700 calculates the CO₂ emission coefficient such that a value obtained by dividing the electric energy to be supplied from the CO₂ emission sources by the total supply electric energy is multiplied by the coefficient W. The coefficient W may be predetermined by experiments or simulations on the CO₂ emission sources. The server 700 may obtain the coefficient W by a known machine learning technology or artificial intelligence using statistical data (e.g., big data).

The method for calculating the CO₂ emission coefficient is not limited to the above. For example, in the above method, the coefficient W common to the thermal power plant 711 and the power grid PG2 is used as the coefficient for converting the electric energy into the amount of carbon dioxide. However, the present disclosure is not limited to this, and different coefficients may be used for the thermal power plant 711 and the power grid PG2. Further, different coefficients may be used depending on the types of thermal power plant (coal thermal power, LNG thermal power, oil thermal power, etc.). In a form in which the power grid PG2 is an RE100 (RE100%) power grid (modification), the power grid PG2 is not the CO₂ emission source. Therefore, only the electric energy to be generated by thermal power generation may be regarded as the CO₂ emission source.

In Data Example 1 shown in FIG. 5, the weather is cloudy and the amount of electric power generated by sunlight is small. For this reason, energy is hardly stored in the pumped storage power plant 713. In Data Example 2 shown in FIG. 6, the weather is fine, the amount of electric power generated by sunlight is large during the daytime (around noon), and the CO₂ emission coefficient (and the environmental load) is small. A large amount of surplus electric power is stored in the pumped storage power plant 713. The server 700 can store the surplus electric power in the vehicle group VG instead of the pumped storage power plant 713 by, for example, performing DR.

The server 700 transmits the CO₂ emission information acquired as described above to the server 200. The transmission interval of the CO₂ emission information is not limited to one day, and may be longer (e.g., one week). In Data Examples 1 and 2 shown in FIGS. 5 and 6, the CO₂ emission information indicates hourly CO₂ emission coefficients. However, the present disclosure is not limited to this, and the CO₂ emission information may indicate CO₂ emission coefficients for every 30 minutes according to the length of the frame in the electric power market. Instead of the CO₂ emission coefficient, an adjusted CO₂ emission coefficient (value that reflects adjustment based on environmental value such as a non-fossil certificate in the CO₂ emission coefficient) may be adopted.

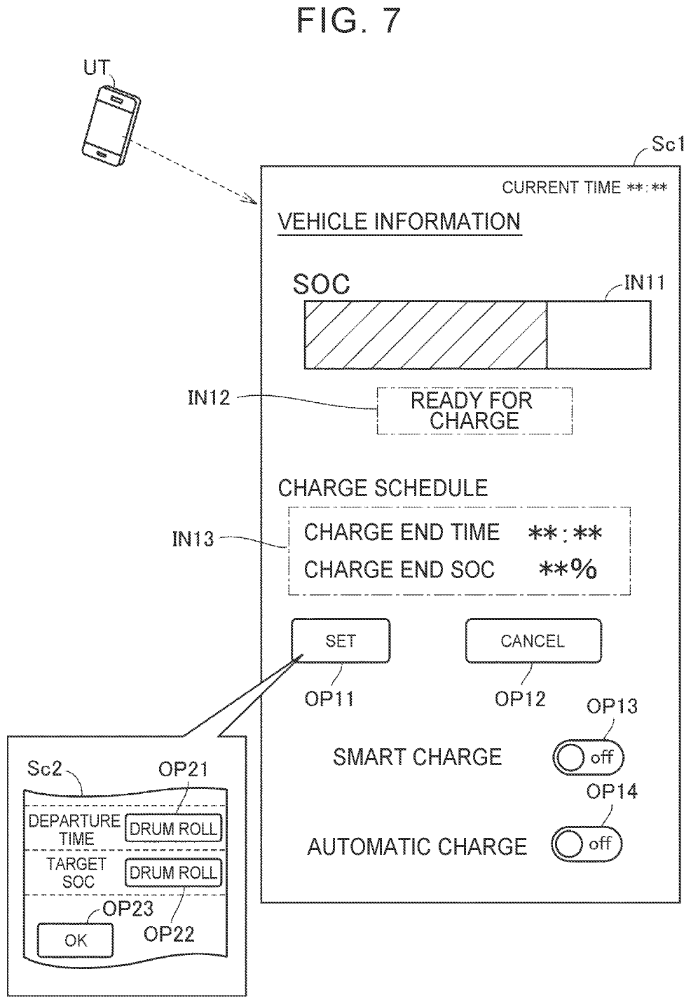

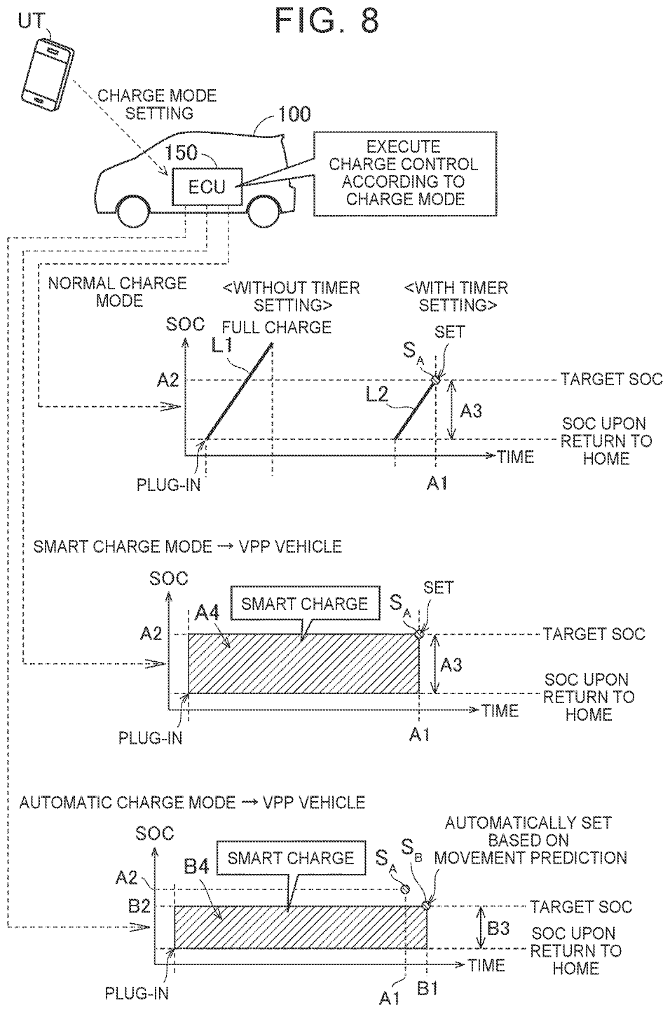

Referring to FIG. 4 again, in S4, the server 200 predicts, on the day before the target day, a normal charge amount of the vehicle group VG for the next day (target day) for each time slot, and transmits the predicted normal charge amount for each time slot to the server 700. The normal charge amount of the vehicle group VG corresponds to a charge amount of the vehicle group VG under the assumption that DR (power balancing) is not performed. A method for calculating the normal charge amount will be described below with reference to FIGS. 7 and 8.

FIG. 7 shows a charge mode setting screen to be displayed by the mobile terminal UT. Referring to FIG. 7, when the mobile app is started on the mobile terminal UT, the mobile app requests user authentication (login). The user can log in by entering the predetermined authentication information to the mobile terminal UT. The mobile terminal UT can acquire the user information on the user who has logged in to the mobile app from the server 200 or 500. After the login, the mobile terminal UT displays a charge mode setting screen Sc1.

The charge mode setting screen Sc1 includes operation sections OP11 to OP14 and information sections IN11 to IN13. The information section IN11 indicates a current SOC of the battery 11. The information section IN12 indicates the charge status of the battery 11 (e.g., ready for charge, charging, or charge complete). The information section IN13 shows information on the next charge (e.g., charge end time, and charge end SOC). In the present embodiment, the information on the next charge that is displayed in the information section IN13 corresponds to information on a use schedule of the vehicle 100 (first information). Specifically, the charge end time of the next charge corresponds to a scheduled use start time (scheduled departure time) of the vehicle 100. The charge end SOC of the next charge corresponds to a target SOC of the battery 11 in the next charge control.

The user can set the use schedule of the vehicle 100 on the mobile terminal UT by operating the operation section OP11 (setting button). Specifically, when the user touches the operation section OP11 on the charge mode setting screen Sc1 (touch panel screen), a use schedule setting screen Sc2 is displayed. The use schedule setting screen Sc2 includes operation sections OP21 and OP22 (drum rolls) and an operation section OP23 (OK button). The user can enter the scheduled departure time of the vehicle 100 by using the operation section OP21 (drum roll). The entered scheduled departure time is set as the charge end time of the next charge. The user can enter the target SOC (charge end SOC) at the scheduled departure time by using the operation section OP22 (drum roll). When the operation section OP23 (OK button) is operated after these pieces of information are entered, the next charge is set (scheduled) on the mobile terminal UT according to the entered details, and information on the set next charge is displayed in the information section IN13.

The user can cancel the use schedule of the vehicle 100 set on the mobile terminal UT by operating the operation section OP12 (cancellation button). When the next charge is not set, the mobile terminal UT may display, in the information section IN13, a message that the next charge is not set.

In the present embodiment, the ECU 150 of the vehicle 100 shown in FIG. 2 sets a charge mode according to an input from the user among a plurality of types of charge modes. Specifically, the mobile terminal UT receives an input of the charge mode from the user on the charge mode setting screen Sc1, and sets the input charge mode for the vehicle 100 (ECU 150). FIG. 8 illustrates three types of charge mode that can be set for the vehicle 100.

Referring to FIGS. 7 and 8, the user can select any charge mode from among the three types of charge mode and set the charge mode for the vehicle 100 by using the operation sections OP13 and OP14 (toggle switches) in the charge mode setting screen Sc1 shown in FIG. 7. For example, when both the operation sections OP13 and OP14 are OFF, the user has selected a first charge mode (hereinafter also referred to as “normal charge mode”). When the operation section OP13 is ON and the operation section OP14 is OFF, the user has selected a second charge mode (hereinafter also referred to as “smart charge mode”). When the operation section OP13 is OFF and the operation section OP14 is ON, the user has selected a third charge mode (hereinafter also referred to as “automatic charge mode”). The operation section OP13 and the operation section OP14 operate in conjunction with each other. When the operation section OP13 is turned ON, the operation section OP14 is turned OFF. When the operation section OP14 is turned ON, the operation section OP13 is turned OFF. When the next charge is not set on the mobile terminal UT, an operation of shifting to the smart charge mode (e.g., operation of turning ON the operation section OP13) is prohibited.

The mobile terminal UT sets the charge mode selected by the user for the vehicle 100 (ECU 150). The mobile terminal UT transmits the charge mode set by using the operation sections OP13 and OP14 to the vehicle 100 together with the information on the set next charge (scheduled departure time and target SOC). The charge mode and the charge schedule (e.g., charge end time and target SOC of next charge) received by the vehicle 100 are set in the ECU 150. The ECU 150 executes charge control on the battery 11 according to the set charge mode. The ECU 150 according to the present embodiment is an example of a “charge control device” according to the present disclosure. Each vehicle in the vehicle group VG includes the charge control device that executes charge control described below in a manner conforming to the ECU 150.

At least one of the servers 200 and 500 receives the charge mode set in the charge control device and the information on the next charge (scheduled departure time and target SOC) from each vehicle in the vehicle group VG or the user terminal of each vehicle. The vehicle in the vehicle group VG in which the normal charge mode is set in the charge control device is hereinafter also referred to as “first mode vehicle”. The vehicle in the vehicle group VG in which the smart charge mode is set in the charge control device is also referred to as “second mode vehicle”. The vehicle in the vehicle group VG in which the automatic charge mode is set in the charge control device is also referred to as “third mode vehicle”.

The first mode vehicle does not permit remote control by the server 200, and charges the power storage device by local control. When the vehicle 100 is the first mode vehicle, different types of charge control are executed depending on whether the next charge is set in the ECU 150. The ECU 150 in which the normal charge mode is set and the next charge is not set (ECU without timer setting) executes immediate charge as indicated by line L1. The immediate charge is external charge that is started as soon as the vehicle enters the plugged-in state. The immediate charge according to the present embodiment is terminated when the power storage device (e.g., the battery 11) is fully charged.

The ECU 150 in which the normal charge mode and the next charge are set (ECU with timer setting) executes the set next charge as indicated by line L2. In FIG. 8, the charge end time and the target SOC of the next charge set in the ECU 150 by the user are indicated by coordinate values S_{A} (end time A1 and target value A2) in the two-dimensional graph of time and SOC. The coordinate values S_{A} define a user requirement. The user requirement according to the coordinate values S_{A} is that the SOC of the battery 11 is equal to or higher than the target value A2 at the end time A1. The ECU with timer setting executes charging during a period immediately before the end time A1. The charging is started so that the SOC of the battery 11 reaches the target value A2 at the end time A1. Thus, the user requirement is satisfied. By executing the charging immediately before the end time A1, the period during which the vehicle 100 is left unattended with the high SOC of the battery 11 is shortened, and deterioration of the battery 11 is suppressed. A charge amount A3 indicates the electric energy input to the battery 11 by the charging according to the coordinate values S_{A}.

When the second mode vehicle participates in DR, the server 200 executes smart charge of the power storage device of the second mode vehicle by remote control. The ECU 150 in which the smart charge mode is set permits the server 200 to execute smart charge of the battery 11 during a smart charge period A4 from the time when the vehicle 100 returns home (time of plug-in) to the end time A1. In the smart charge of the second mode vehicle, the server 200 can freely execute charge control as long as the user requirement according to the coordinate values S_{A} is satisfied. Through the smart charge, the SOC of the battery 11 is increased by the charge amount A3 from the SOC when the vehicle 100 returns home.

When the server 200 does not permit the second mode vehicle to participate in DR, the server 200 does not remotely control the second mode vehicle. In this case, the second mode vehicle executes charge control similar to that of the first mode vehicle.

The ECU 150 in which the automatic charge mode is set permits the server 200 to set a charge schedule and execute smart charge of the battery 11 based on the set charge schedule. The server 200 uses a result of the prediction of movement of the vehicle 100 (S22 in FIG. 4) to set the charge schedule (charge end time and target SOC of next charge) of the vehicle 100, for example, as described below. The server 200 may predict the movement of the vehicle 100 by using a trained model obtained by machine learning using AI. An operation of shifting to the automatic charge mode (e.g., operation of turning ON the operation section OP14 shown in FIG. 7) may be prohibited until learning is completed. When learning for movement prediction is completed, the mobile terminal UT may display a general description of the automatic charge mode as a pop-up.

For the third mode vehicle, the server 200 acquires the use schedule of the vehicle (scheduled use start time and electric energy for next use) by using the result of vehicle movement prediction, and sets a charge schedule associated with the obtained use schedule in the charge control device. When the vehicle 100 is the third mode vehicle, the server 200 acquires, for the vehicle 100, the scheduled use start time and the electric energy for the next use (e.g., electric energy necessary for next traveling) from the predicted movement schedule. The server 200 sets the acquired scheduled use start time as a charge end time of the next charge, and sets the target SOC of the next charge so that the battery 11 can store an electric energy suitable for the next use (proper amount of electric energy). In FIG. 8, the charge end time and the target SOC of the next charge set in the ECU 150 by the server 200 are indicated by coordinate values S_{B} (end time B1 and target value B2) in the two-dimensional graph of time and SOC. When the charge schedule (coordinate values S_{A}) has already been set, the server 200 changes the charge schedule from the coordinate values S_{A} to the coordinate values S_{B}. The coordinate values S_{B} define the user requirement. The user requirement according to the coordinate values S_{B} is that the SOC of the battery 11 is equal to or higher than the target value B2 at the end time B1.

When the third mode vehicle participates in DR, the server 200 executes smart charge of the power storage device of the third mode vehicle by remote control. When the vehicle 100 is the third mode vehicle, the server 200 executes smart charge of the battery 11 by remote control during a smart charge period B4 from the time when the vehicle 100 returns home (time of plug-in) to the end time B1. In the smart charge of the third mode vehicle, the server 200 can freely execute charge control as long as the user requirement according to the coordinate values S_{B} is satisfied. Through the smart charge, the SOC of the battery 11 is increased by a charge amount B3 from the SOC when the vehicle 100 returns home (at the time of plug-in).

When the server 200 does not permit the third mode vehicle to participate in DR, the server 200 does not remotely control the third mode vehicle. In this case, the third mode vehicle executes charge control similar to that of the first mode vehicle.

The server 200 performs DR by the smart charge. A vehicle in the vehicle group VG that does not participate in DR will hereinafter be referred to as “non-VPP vehicle”. For example, the first mode vehicle does not participate in DR and is therefore the non-VPP vehicle. A vehicle in the vehicle group VG that participates in DR will be referred to as “VPP vehicle”.

Referring to FIG. 4 again, in the present embodiment, a charge amount of the vehicle group VG under the assumption that all the vehicles in the vehicle group VG are non-VPP vehicles corresponds to the normal charge amount of the vehicle group VG (S4). The charge amount of the vehicle group VG means the total value of electric energies obtained by external charge of all the vehicles in the vehicle group VG. The non-VPP vehicle executes the charge control in the normal charge mode. For each vehicle in the vehicle group VG, the server 200 obtains a charge amount according to the charge control in the normal charge mode (normal charge amount) for each time slot based on whether timer setting is made (next charge is set) and the charge end time and the target SOC of the set next charge. In the present embodiment, the normal charge amount is calculated for each of the 48 frames that segment the target day. The server 200 calculates a normal charge amount (normal charge plan) of the vehicle group VG for each time slot on the target day by adding up the normal charge amounts obtained for the individual vehicles for each time slot. The server 200 transmits the calculated normal charge plan of the vehicle group VG to the server 700.

In S5, the server 700 determines whether to request DR from the server 200 (aggregator) for each time slot on the target day based on the normal charge plan of the vehicle group VG received from the server 200 and supply and demand prediction and a procurement plan on the target day (see, for example, FIGS. 5 and 6). The server 700 may check the supply and demand balance on the power system PS1 for each time slot, and request the server 200 to perform DR (upward DR or downward DR for eliminating imbalance) for a time slot in which an imbalance is predicted to occur. The server 700 transmits, to the server 200, a DR request signal including information on DR to be requested from the server 200 (hereinafter referred to as “DR information”). The server 700 requests the server 200 to perform power balancing of the power system PS1 by transmitting the DR request signal. The server 700 and the DR request signal are examples of a “request device” and a “request signal” according to the present disclosure, respectively.

The DR information indicates details of requested power balancing for each time slot. Specifically, the DR information indicates whether there is a DR request for each time slot. The DR information also indicates the type of requested DR for the time slot in which the DR request is made. The DR information according to the present embodiment indicates “no DR”, “upward DR”, or “downward DR” for each of the 48 frames that segment the target day. Upward DR is DR that basically requests a demand increase. However, when the DERs receiving a request are power generating equipment, upward DR may request supply curtailment from the DERs. Downward DR is DR that requests a demand reduction or reverse power flow. The DR information may further indicate at least one of the purpose of DR (CO₂ reduction, cost reduction, tight supply and demand, etc.), a DR request amount, a DR priority level, and cost information.

In S6, the server 200 determines a charge plan of each vehicle in the vehicle group VG, and determines a possible DR amount of the vehicle group VG for each time slot based on the determined charge plan of each vehicle. The server 200 transmits the determined possible DR amount of the vehicle group VG for each time slot to the server 700. The possible DR amount of the vehicle group VG corresponds to an electric energy that can be balanced by the vehicle group VG for the power system PS1. The process of S6 will be described below.

For the first mode vehicle in the vehicle group VG, the server 200 determines a charge plan in the normal charge mode (i.e., a charge plan according to the charge schedule set by the user) as the charge plan on the target day. The server 200 predicts a return time (plug-in time) of each vehicle in the vehicle group VG on the target day by using the result of vehicle movement prediction (S22). The server 200 determines a charging plan (more specifically, a smart charge plan) of each of the second and third mode vehicles in the vehicle group VG on the target day by using the DR request signal (S5) received from the server 700, the information on the use schedule of the vehicle (e.g., the coordinate values S_{A} or S_{B} shown in FIG. 8), and the CO₂ emission information (S3). The smart charge plan indicates a schedule for smart charge to be executed when the second or third mode vehicle participates in DR. The charge plan of each vehicle in the vehicle group VG is an example of a “power balancing plan” according to the present disclosure.

Specifically, for the second mode vehicle in the vehicle group VG, the server 200 determines the smart charge plan on the target day by using the end time A1 (scheduled use start time) and the target value A2 (target SOC) set in the charge control device by the user and the CO₂ emission information (see FIG. 8). For the third mode vehicle in the vehicle group VG, the server 200 sets the end time B1 (scheduled use start time) and the target value B2 (target SOC) in the charge control device by using the result of movement prediction, and determines the smart charge plan on the target day by using the set end time B1, the set target value B2, and the CO₂ emission information (see FIG. 8).

The server 200 according to the present embodiment determines the charge plan of each vehicle in the vehicle group VG on the target day so that the charge amount of the vehicle group VG (total charge energy of all the vehicles) is larger than the normal charge amount (reference value) of the vehicle group VG during a time slot in which upward DR is requested (time slot in which the DR request signal requests an increase in power demand) and the charge amount of the vehicle group VG (total charge energy of all the vehicles) is smaller than the normal charge amount (reference value) of the vehicle group VG during a time slot in which downward DR is requested (time slot in which the DR request signal requests a reduction in power demand). The server 200 determines the smart charge plan of each of the second and third mode vehicles in the vehicle group VG on the target day so that both the predetermined user requirement and the predetermined environmental requirement are satisfied. In the present embodiment, the user requirement is satisfied when the SOCs of the power storage devices of all the vehicles in the vehicle group VG are equal to or higher than the target SOC at the scheduled use start time. The environmental requirement is satisfied when the total value of the amounts of carbon dioxide emitted in the process of generating electric power (charge power) to be used in the charge plans of all the vehicles in the vehicle group VG is equal to or smaller than a predetermined target level.

For each of the second and third mode vehicles, the server 200 adjusts the smart charge plan to the use schedule of each vehicle so that the user requirement is satisfied. For the first mode vehicle, the user requirement is satisfied because the charge control in the normal charge mode is executed. The server 200 can acquire the amount of carbon dioxide emitted in the process of generating electric power to be used in the charge plan of the first mode vehicle based on the use schedule of the first mode vehicle (and the charge plan of the first mode vehicle) and the CO₂ emission information (S3). For each of the second and third mode vehicles, the server 200 adjusts the smart charge plan (i.e., the charge amount for each time slot) of each vehicle so that the environmental requirement is satisfied. For example, in the smart charge plan of each vehicle, the server 200 reduces the charge amount during a time slot in which the CO₂ emission coefficient is large or increases the charge amount during a time slot in which the CO₂ emission coefficient is small. Therefore, the environmental load of electric power decreases and the environmental requirement can be satisfied more easily.

The target level in the environmental requirement may be a fixed value. Alternatively, the server 200 may variably set the target level depending on the electricity rate. The server 200 may increase the target level as the unit electricity rate (e.g., an electricity rate per unit electric energy) increases. Prior to determining the charge plan of each vehicle, the server 200 may prompt the user of the vehicle to change the use schedule of the vehicle in order to reduce the environmental load of electric power. For example, the server 200 may transmit, to the user terminal, a notification for requesting a change in the use schedule of the vehicle to reduce the environmental load of electric power.

The method for determining the charge plan of each vehicle is not limited to the above. For example, the server 200 may determine the charge plan of each vehicle in the vehicle group VG so that the user requirement is satisfied and the total value of the amounts of carbon dioxide emitted in the process of generating electric power to be used in the charge plan of each vehicle is minimized. Alternatively, the server 200 may determine the charge plan of each vehicle by further using cost information on the electricity rate in addition to the DR information, the user requirement, and the environmental requirement. The server 200 may determine the charge plan of each vehicle based on the result of comprehensive evaluation of the environmental load and the electricity rate. The server 200 may determine the charge plan of each vehicle so that both the user requirement and the environmental requirement are satisfied and the total value of electricity rates required for charging according to the charge plans of the vehicles is minimized. The server 200 may create the charge plan of each vehicle by using an objective function. The server 200 may create the charge plan of each vehicle by using a trained model obtained by machine learning using AI.

In S6, the server 200 determines the charge plan of each vehicle in the vehicle group VG as described above. The determined charge plan of each vehicle is registered in the storage device 202 (FIG. 3) of the server 200. The charge plan according to the present embodiment indicates transition of the SOC of the power storage device. However, the present disclosure is not limited to this, and the charge plan may indicate transition of the charge power of the power storage device.

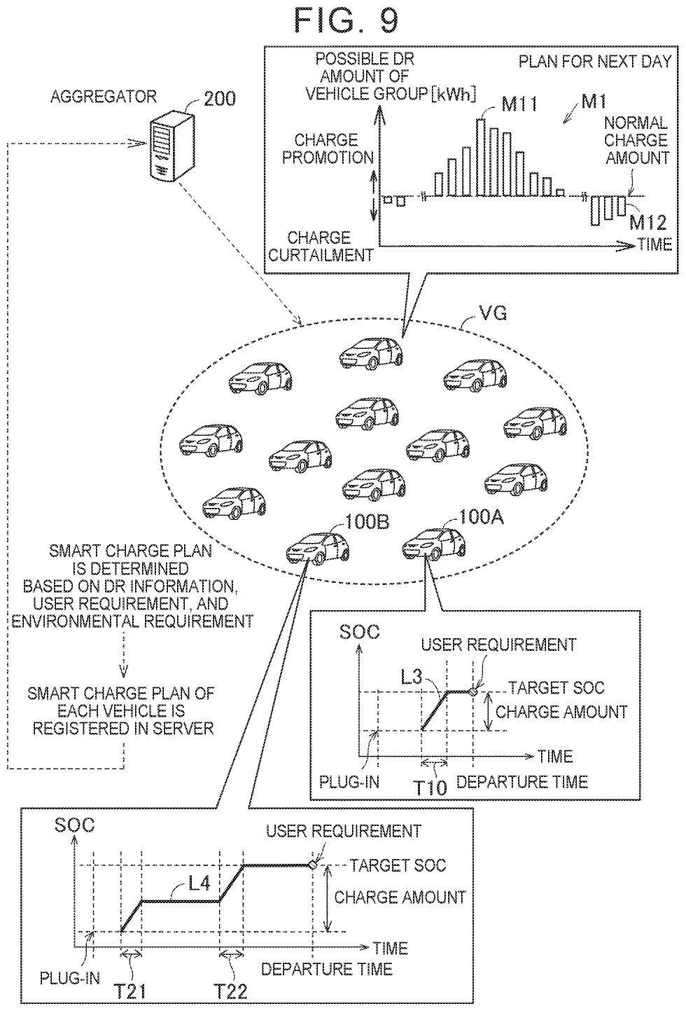

FIG. 9 illustrates the smart charge plan and the possible DR amount in the present embodiment.

Referring to FIG. 9, line L3 indicates a smart charge plan of a vehicle 100A in the vehicle group VG. In the smart charge plan of the vehicle 100A, charging is performed once during a period T10 shown in FIG. 9. Specifically, charging of the power storage device is started at a timing earlier than that of the charge control in the normal charge mode, and the SOC of the power storage device reaches the target SOC before the scheduled departure time of the vehicle 100A. Line L4 indicates a smart charge plan of a vehicle 100B in the vehicle group VG. In the smart charge plan of the vehicle 100B, charging is performed twice separately during a period T21 and a period T22 shown in FIG. 9. By the charging performed twice, the SOC of the power storage device reaches the target SOC. The smart charge plan is not limited to these, and the server 200 determines the charging timing, the charging speed, the number of charging operations, etc. as appropriate.

As described above, in the smart charge, the server 200 can freely execute charge control as long as the user requirement is satisfied. The server 200 determines a charging period and a non-charging period in the smart charge plan based on, for example, the DR information, the user requirement, and the environmental requirement. By changing the charging period and the non-charging period, the charge amount for each time slot changes. The server 200 can adjust the charge amount of the vehicle group VG for each time slot by adjusting the charge amount for each time slot in the smart charge plan of each of the second and third mode vehicles.

The server 200 determines the possible DR amount of the vehicle group VG for each time slot on the target day based on the charge plan of each vehicle in the vehicle group VG on the target day that is determined by the above method. Specifically, the server 200 sets the possible DR amount of the vehicle group VG for each time slot to a charge amount of the vehicle group VG for each time slot under the assumption that each vehicle in the vehicle group VG operates according to the charge plan. The server 200 may calculate the charge amount of each vehicle in consideration of the breaker capacity at the charging location of each vehicle. In FIG. 9, a graph M1 shows an example of the possible DR amount of the vehicle group VG for each time slot. In the present embodiment, the possible DR amount of the vehicle group VG is expressed with the normal charge amount of the vehicle group VG as a reference (zero point). That is, the possible DR amount (kWh) of the vehicle group VG according to the present embodiment corresponds to a difference between the charge amount of the vehicle group VG according to the charge plan of each vehicle and the normal charge amount of the vehicle group VG. In the graph M1, data M11 indicates an electric energy that can be balanced by the vehicle group VG toward a charge promotion side (positive side), and is in a time slot in which upward DR is requested. Data M12 indicates an electric energy that can be balanced by the vehicle group VG toward a charge curtailment side (negative side), and is in a time slot in which downward DR is requested. The server 200 transmits the determined possible DR amount of the vehicle group VG for each time slot on the target day to the server 700.

Referring to FIG. 4 again, in S7, the server 700 determines a DR request amount (DR plan) for each time slot on the target day based on the possible DR amount of the vehicle group VG for each time slot on the target day that is received from the server 200. The server 700 determines the DR plan of the vehicle group VG in consideration of the conditions of the DERs other than the vehicle group VG. The DR request amount means a power balancing amount requested by DR. The DR plan according to the present embodiment indicates a DR request amount for each of the 48 frames that segment the target day. The DR plan of the vehicle group VG indicates a power balancing amount for each time slot that is requested by the server 700 (retail electric power company) from the server 200 (aggregator). The possible DR amount and the DR request amount (power balancing amount) are expressed by a common reference. That is, the power balancing amount of the vehicle group VG corresponds to an amount of increase or decrease in the charge amount of the vehicle group VG with respect to the normal charge amount (reference) of the vehicle group VG. The DR plan is determined so that the DR request amount is within the range of the possible DR amount in each time slot. The server 700 transmits the determined DR plan of the vehicle group VG to the server 200. The server 700 may request DR from other DERs in addition to the vehicle group VG.

The processes of S4 to S7 are executed on the day before the day of DR (day before the target day). On the day of DR (target day), processes of S8 to S11 are executed in sequence.

In S8, the server 700 determines whether to modify the DR plan (S7) transmitted to the server 200 on the day before the day of DR based on a supply and demand status in the area PS2, a power procurement status, and a power trading status. For example, when a deviation occurs on the day of DR in terms of demand prediction or power generation prediction for the day before the day of DR, the server 700 may modify the DR plan based on the prediction deviation. The server 700 may buy or sell electric power in the hour-ahead market and modify the DR plan of the vehicle group VG for economic benefit. When the server 700 determines to modify the DR plan of the vehicle group VG, the server 700 modifies the DR plan and transmits a DR modification signal including the modified DR plan to the server 200. When the server 700 determines not to modify the DR plan of the vehicle group VG, the server 700 transmits a DR confirmation signal to the server 200.

In S9, the server 200 determines whether to perform DR in response to the request from the server 700 based on the DR modification signal or the DR confirmation signal received from the server 700 and the current status of each vehicle in the vehicle group VG. When the server 200 receives the DR modification signal, the modified DR plan indicated by the DR modification signal is the final DR plan. When the server 200 receives the DR confirmation signal, the DR plan received in S7 is the final DR plan. The final DR plan will hereinafter be referred to also as “intraday plan”.

The server 200 updates the possible DR amount (S6) of the vehicle group VG for each time slot based on the latest use schedule and vehicle information of each vehicle in the vehicle group VG. The server 200 determines whether the vehicle group VG can perform the requested DR by comparing the updated possible DR amount of the vehicle group VG for each time slot with the intraday plan. When determination is made that the vehicle group VG cannot perform DR, the server 200 transmits a DR non-participation signal to the server 700. In this case, the series of processes related to DR shown in FIG. 4 is terminated.

When the possible DR amount is insufficient for the intraday plan, the server 200 may prompt the user of the vehicle to change the use schedule of the vehicle to increase the possible DR amount. For example, the server 200 may transmit, to the user terminal, a notification for requesting a change in the use schedule of the vehicle to increase the possible DR amount. An incentive for the change may be indicated in the notification. When the user responds to the request from the server 200 and the shortage of the possible DR amount is resolved, the server 200 may transmit a DR participation signal described below to the server 700 instead of the DR non-participation signal.

When determination is made that the vehicle group VG can perform DR, the server 200 transmits the DR participation signal to the server 700. Then, the server 200 executes a process for performing DR. When the server 200 receives the DR modification signal (modification request from the server 700), the server 200 modifies at least one of the charge plans of the vehicles that have been determined in S6 so that DR is performed according to the modified DR plan (intraday plan) indicated by the DR modification signal. As in the method for determining the charge plan (S6), the server 200 may modify the charge plan of each vehicle so that the user requirement and the environmental requirement are satisfied by using the information on the use schedule of the vehicle (scheduled use start time and target SOC) and the CO₂ emission information (S3). Even when the server 200 receives the DR confirmation signal, the server 200 modifies at least one of the charge plans of the vehicles that have been determined in S6 so that DR is performed according to the intraday plan and the user requirement and the environmental requirement are satisfied by using the intraday plan, the information on the use schedule of the vehicle, and the CO₂ emission information. The modification is not executed when DR is performed according to the intraday plan and the user requirement and the environmental requirement are satisfied with the charge plans of the vehicles that have been determined in S6.

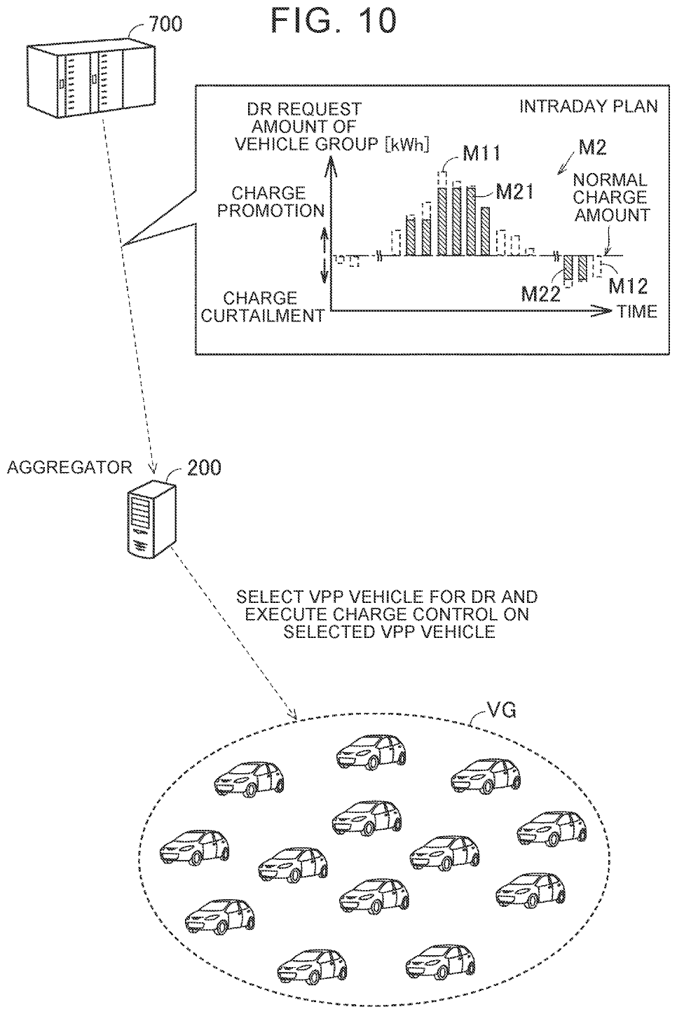

In S10, the server 200 causes a vehicle whose charge plan is not modified in S9 to operate according to the charge plan determined in S6, and causes a vehicle whose charge plan is modified in S9 to operate according to the charge plan modified in S9. Thus, each vehicle in the vehicle group VG operates according to the charge plan determined in S6 or the charge plan modified in S9. FIG. 10 illustrates a process (S10 in FIG. 4) related to power balancing of the power system PS1 (external power supply) to be executed by the server 200.

Referring to FIG. 10, a graph M2 shows an example of the intraday plan. In the graph M2, data M21 indicates a DR request amount on the charge promotion side (positive side), and data M22 indicates a DR request amount on the charge curtailment side (negative side). Both the DR request amounts are set within the range of the possible DR amount (see FIG. 9) of the vehicle group VG.

In S10 of FIG. 4, the server 200 executes remote control on a control target. Prior to this, the server 200 selects a control target for power balancing of the power system PS1 from among the second and third mode vehicles in the vehicle group VG. The control target may be selected when the charge plan of each vehicle is determined in S9. The server 200 does not perform smart charge of the non-VPP vehicle. Therefore, the charge plan of the non-VPP vehicle is the charge plan set by the user (same charging plan as that in the normal charge mode). The control target corresponds to the VPP vehicle. The server 200 selects the control target for each time slot (frame) based on the intraday plan. The number of control targets is determined based on the DR request amount indicated by the intraday plan. The server 200 transmits a control command according to the corresponding smart charge plan to each selected control target, thereby causing the control target to execute charge control for power balancing of the power system PS1. The power balancing of the power system PS1 is performed by the smart charge (see FIG. 9).

The server 200 remotely controls the VPP vehicle (control target) as described above. Specifically, the charge control device of the VPP vehicle controls the on-board charger (e.g., the charger 61 shown in FIG. 2) according to the control command transmitted from the server 200 as needed. The charge control device may switch ON (execution) and OFF (stop) of charging according to the control command, or may balance the charge power to follow a value indicated by the control command. However, the charge control method can be changed as appropriate. For example, an electromagnetic contactor (e.g., the charging relay 62 shown in FIG. 2) may be controlled instead of the on-board charger.

The server 200 does not execute charge control on the non-VPP vehicle for power balancing of the power system PS1. In addition to the first mode vehicle, the second and third mode vehicles that are not selected as control targets also correspond to the non-VPP vehicles. In the vehicle group VG, the VPP vehicle operates according to the predetermined charge plan (charge plan determined in S6 or charge plan modified in S9) under the remote control of the server 200, and the non-VPP vehicle operates according to the predetermined charge plan under the local control of the on-board control device (charge control device). The non-VPP vehicle performs normal charge of the power storage device (charge control in the normal charge mode) according to the charge schedule set by the user. The server 200 may change the VPP vehicle during DR in order to carry out the intraday plan. For example, when any VPP vehicle (control target) becomes unable to be charged during DR, the server 200 may change any non-VPP vehicle to a VPP vehicle as a substitute control target.

As described above, the server 200 manages each vehicle in the vehicle group VG so that each vehicle operates according to the charge plan determined in S6 or the charge plan modified in S9. In the present embodiment, power balancing of the power system PS1 (external power supply) is performed by remote control. However, the present disclosure is not limited to this, and the server 200 may manage the vehicle group VG so that power balancing of the external power supply is performed by local control. For example, the server 200 may set the predetermined charge plan (charge plan determined in S6 or charge plan modified in S9) in the charge control device of the selected control target (VPP vehicle) and the charge control device of the VPP vehicle may execute charge control on the power storage device according to the charge plan set by the server 200.

Referring to FIG. 4 again, when DR is performed on the target day based on the intraday plan and is completed by the process of S10, the server 200 acquires a control record of each vehicle in the vehicle group VG on the target day from the server 500 in S11. The server 200 transmits, to the server 700, control record information including the control record and the vehicle ID of each vehicle.

The control record includes a charge start time, a charge end time, a charge energy per unit time, and transition of the SOC of the power storage device and transition of the position of the vehicle. These are data detected by on-board sensors on the target day. The control record information indicates DR participation or non-participation of each vehicle on the target day (VPP vehicle or non-VPP vehicle). The information on each vehicle is distinguished by the vehicle ID. The user ID may be adopted instead of the vehicle ID. The control record information may include the charging location of each vehicle. The server 200 may transmit, to the server 700, control records of only the VPP vehicles instead of that of the entire vehicle group VG.

In S12, the server 700 identifies the charging location of each vehicle based on the vehicle ID of each vehicle received from the server 200. The server 700 acquires a DR record of each charging location based on the measurement value of the watt-hour meter (e.g., the smart meter) installed at each charging location of each vehicle. The DR record includes a DR record amount, an environmental index (e.g., an index indicating the magnitude of CO₂ emission along with DR), and a cost index (e.g., an index indicating the level of the electricity rate required for DR). The DR record amount is an actual value (power balancing amount) with respect to the DR request amount. In downward DR, non-execution of charging may contribute to the DR record (record of power balancing). The server 700 transmits the DR record of each charging location to the server 200 together with the user ID associated with each charging location.

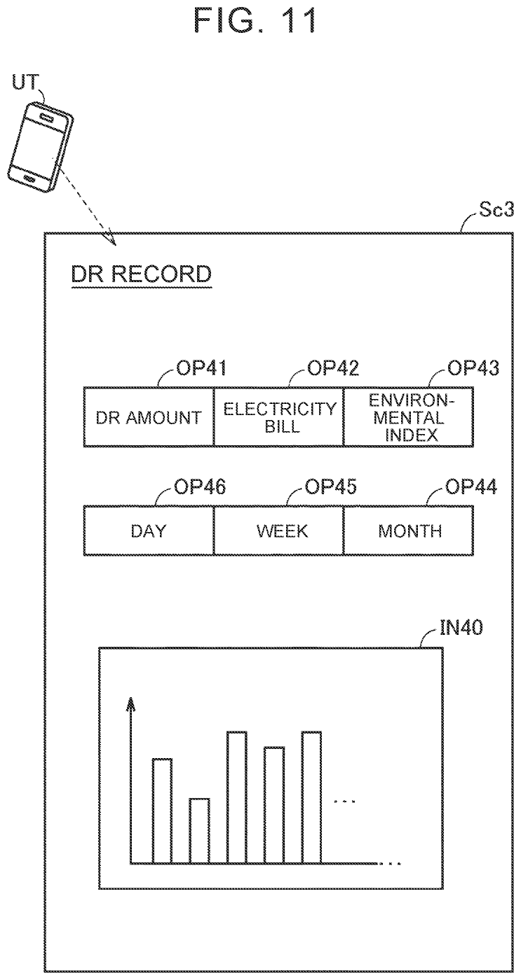

In S13, the server 200 causes the user terminal to display the DR record. Specifically, the server 200 transmits the DR record of each charging location received from the server 700 to the user terminal associated with each charging location. Each user terminal displays the DR record received from the server 200. Thus, each user can view and check his/her DR record. FIG. 11 shows an example of a screen on which the user terminal (e.g., the mobile terminal UT) displays the DR record.

Referring to FIG. 11, the mobile terminal UT displays a screen Sc3 when a new DR record is received from the server 200. The screen Sc3 includes an information section IN40 and operation sections OP41 to OP46. The mobile terminal UT displays data specified by the user on the information section IN40. Specifically, the mobile terminal UT displays data specified by using the operation sections OP41 to OP46 on the information section IN40. In the example shown in FIG. 11, the data is displayed as a bar graph, but the display format of the information section IN40 is not limited to the bar graph and can be changed as appropriate. For example, the data may be displayed as a line graph or in the form of a table. The mobile terminal UT may change the display format in response to a request from the user.

The operation sections OP41 to OP43 receive an input of the type of data to be displayed in the information section IN40. The type of data to be displayed is switched by using the operation sections OP41 to OP43. When the operation sections OP41, OP42, OP43 are operated, the DR record amount, the cost index, and the environmental index are displayed in the information section IN40, respectively. The operation sections OP44 to OP46 receive an input of a data period to be displayed in the information section IN40. The horizontal axis of the graph is switched by using the operation sections OP44 to OP46. When the operation sections OP44, OP45, OP46 are operated, data for the last one month, the last one week, and the previous day are displayed in the information section IN40, respectively. The mobile terminal UT may further display incentive information described below in addition to the DR record.

Referring to FIG. 4 again, in S14, the server 700 gives an incentive associated with the DR record to the user of each VPP vehicle. The server 700 may determine the value of the incentive to be given to the user based on the DR record amount and the environmental index of the VPP vehicle. The server 700 may increase the value of the incentive as the environmental load along with DR decreases. The server 700 may determine the value of the incentive for each VPP vehicle in consideration of not only the DR record (S12) but also the control record information (S11). The server 700 transmits incentive information indicating the value of the incentive (e.g., money or points) acquired by the vehicle user to the user terminal. Examples of a method for giving the incentive to the user include assignment to an electricity bill, direct deposit, awarding of points, delivery of goods, and donation in the user's name. The retail electric power company (server 700) may give the incentive to each user via the aggregator (server 200). For example, the retail electric power company may transfer the incentive to the aggregator, and the aggregator may distribute the incentive to each user.

As described above, the power balancing method according to the present embodiment includes the processes of S1 to S14 shown in FIG. 4. In S6, the management device 1000 (more specifically, the server 200) determines the charge plan (power balancing plan) of the power storage device of each vehicle in the vehicle group VG by using the information on the use schedule of each vehicle (first information) and the CO₂ emission information (second information) related to the power supply in the power system PS1. In S10, in DR (power balancing of the power system PS1), each vehicle in the vehicle group VG operates according to the charge plan determined in S6 or the charge plan modified in S9.

According to the power balancing method described above, it is possible to determine the charge plan in consideration of both the use schedule of each vehicle and the magnitude of the environmental load of electric power (environmental load along with power supply). In the power balancing method described above, the power balancing of the external power supply is performed by using the vehicle group VG (plurality of vehicles). Therefore, it is possible to reduce the overall environmental load of electric power received by the entire vehicle group VG by determining the charge plans of the vehicles to complement each other. According to the power balancing method described above, the power balancing of the external power supply can appropriately be performed by using the vehicles while securing sufficient convenience for the users of the vehicles and reducing the environmental load along with the power supply.

The series of processes shown in FIG. 4 can be changed as appropriate. For example, the server 200 need not transmit the normal charge plan of the vehicle group VG calculated in S4 to the server 700. In the above embodiment, the possible DR amount is defined with the normal charge amount as a reference, but the reference of the possible DR amount can be changed as appropriate. The possible DR amount may be defined with a predetermined value (fixed value) as a reference. For example, the possible DR amount may be defined by setting a reference (zero point) to a state in which none of the vehicles in the vehicle group VG is charged or discharged.

In the above embodiment, only the schedule for the next charge is set on the user terminal (mobile terminal UT). However, the present disclosure is not limited to this, and a plurality of charge schedules for a predetermined period (e.g., one week) may collectively be set on the user terminal. Instead of the mobile terminal, a terminal installed at the home or workplace of the vehicle user or an on-board terminal (e.g., the HMI 81) may be adopted as the user terminal.

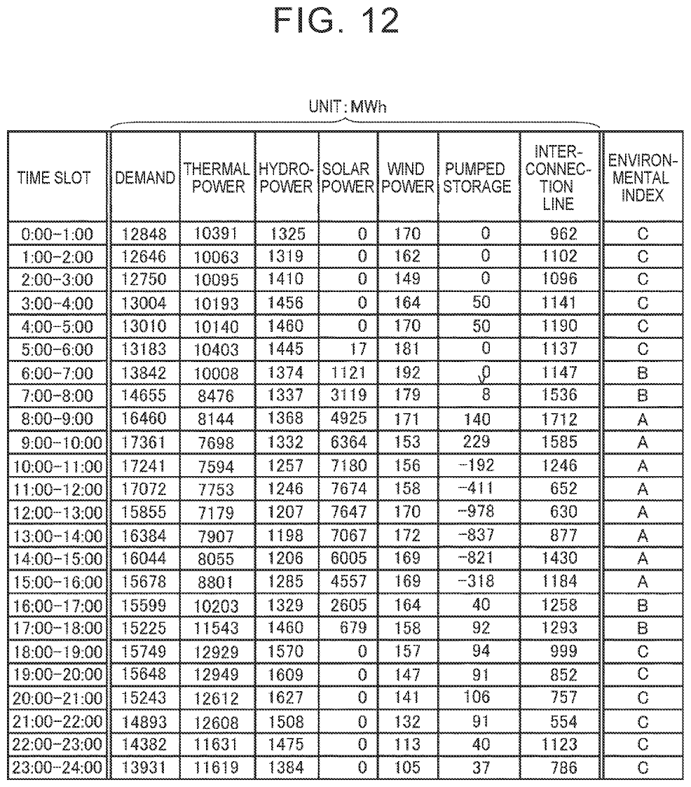

The environmental information (second information) is not limited to the CO₂ emission information shown in FIGS. 5 and 6. The environmental index for each time slot in the environmental information may be a grade of the amount of carbon dioxide emitted in the process of power generation. For example, an environmental index shown in FIG. 12 may be adopted instead of the environmental index shown in FIG. 6. FIG. 12 shows a modification of the environmental index shown in FIG. 6.

Referring to FIG. 12, the environmental index according to the present modification indicates the amount of carbon dioxide emitted in the process of power generation while being distinguished by “A (small)”, “B (medium)”, and “C (large)”. It is possible to indicate the magnitude of the environmental load in the process of power generation by using such an environmental index. The number of divisions is not limited to three (A to C), and may be four or more.

In the above embodiment and modification, carbon dioxide is exemplified as a substance with a large environmental load. However, the present disclosure is not limited to this, and the environmental information (second information) may indicate the amount of emission of a substance with a large environmental load other than carbon dioxide (methane, nitrous oxide, fluorocarbon, etc.) instead of or in addition to carbon dioxide.

The power balancing plan (charge plan) according to the above embodiment indicates the charge amount of electric power from the external power supply for each of the 48 frames that segment one day in units of 30 minutes. The period of the plan is not limited to one day and can be changed as appropriate. The length of the frame (time slot) that constitutes the power balancing plan can also be changed as appropriate. For example, one day may be segmented into 24 frames in units of one hour or into 144 frames in units of 10 minutes. The power balancing amount defined by the power balancing plan can be changed as appropriate depending on the type of resource. For example, the power balancing plan may indicate the amount of electric power consumed from or discharged to the external power supply.

At least one vehicle in the vehicle group VG may be capable of reverse power flow to the power system PS1. The vehicle may be capable of external power feeding (i.e., power feeding to the outside of the vehicle using electric power from the power storage device mounted on the vehicle). The vehicle may include a charger-discharger instead of the charger. The vehicle may electrically be connected to the power system PS1 via electric vehicle supply equipment (EVSE). The vehicle may perform power balancing of the power system PS1 by external power feeding. Each of the second and third mode vehicles may permit the server 200 to perform smart charge and discharge instead of the smart charge. The smart charge and discharge may be control in which the server 200 can freely adjust the charge and discharge power of the power storage device as long as the user requirement is satisfied. The server 200 may execute vehicle control (e.g., charge and discharge control) via at least one of EVSE and HEMS.

The power system PS1 (external power supply) is not limited to a large-scale alternating current grid, and may be a microgrid or a direct current (DC) grid. The configuration of the management system is not limited to the configuration shown in FIG. 1. Another server (e.g., a server of a higher-level aggregator) may be provided between the server 700 and the server 200. The server 200 may directly communicate with the vehicle group VG wirelessly. The functions of the server 500 may be implemented in the server 200 and the server 500 may be omitted. In the above embodiment, the on-premise servers (servers 200, 500 shown in FIG. 1) function as the management device 1000 (management computer). However, the present disclosure is not limited to this, and the functions of the servers 200, 500 (particularly, the functions related to vehicle management) may be implemented in a cloud by cloud computing. The management device 1000 may belong to any other electric power company (e.g., the retail electric power company or the TSO) rather than to the aggregator.

The configuration of the vehicle is not limited to the configuration described above (see FIG. 2). For example, the vehicle may be an xEV other than the BEV (plug-in hybrid electric vehicle (PHEV), fuel cell electric vehicle (FCEV), range extender EV, etc.). The vehicle may be rechargeable wirelessly. The vehicle may include a solar panel. The vehicle may be configured to perform autonomous driving or may have a flight function. The vehicle is not limited to a four-wheeled passenger car, and may be a bus or a truck. The vehicle may be a Mobility-as-a-Service (MaaS) vehicle. The MaaS vehicle is a vehicle managed by a MaaS operator. The vehicle may be an unmanned vehicle (e.g., a robotaxi, an automated guided vehicle (AGV), or an agricultural machine). The vehicle may be a small-sized unmanned or single-seater BEV (e.g., a three-wheeled BEV, a last-mile BEV, or an electric skater).

The resource may be a moving object other than an automobile (railroad vehicle, ship, airplane, walking robot, drone, robot cleaner, etc.). The resource may be various household electric appliances, or may be at least one of a stationary power storage device and power generation equipment to be used outdoors. In the above embodiment, DR (power balancing) is requested only from the vehicle 100 at the power receiving point where the smart meter 310 shown in FIG. 1 is installed, but may be requested from the entire residence 300 including all the electric devices connected to the distribution board 320.

The various modifications described above may be implemented in any combination. The embodiment disclosed herein should be considered as illustrative and not restrictive in all respects. The scope of the present disclosure is shown by the claims rather than by the above description of the embodiment and is intended to include all modifications within the meaning and scope equivalent to those of the claims.

What is claimed is:

1. A management system comprising:
a plurality of resources configured to be electrically connected to an external power supply; and
a management device configured to manage the resources, wherein
the management device includes
a planning unit configured to determine a power balancing plan of each of the resources by using first information on a use schedule of each of the resources and second information indicating a magnitude of an environmental load in a process of generating electric power to be supplied by the external power supply, and
a management unit configured to manage the resources to cause each of the resources to operate according to the power balancing plan or a modified power balancing plan in power balancing of the external power supply.

2. The management system according to claim 1, wherein:
the resources include a plurality of vehicles;
each of the vehicles includes a power storage device and a charge control device configured to execute charge control on the power storage device;
the power balancing plan is a charge plan of the power storage device;
the charge control device of the vehicle is configured to set a scheduled use start time of the vehicle and a target state of charge of the power storage device in the charge control; and
the first information indicates the scheduled use start time and the target state of charge set in the charge control device.

3. The management system according to claim 2, wherein:
the second information indicates, for each time slot, an amount of carbon dioxide emitted in the process of generating the electric power to be supplied by the external power supply; and
the planning unit is configured to determine the charge plan of each of the vehicles to satisfy a condition that a state of charge of the power storage device in each of the vehicles is equal to or higher than the target state of charge at the scheduled use start time, and a condition that a total value of the amounts of carbon dioxide emitted in the process of generating the electric power to be used in the charge plan of each of the vehicles is equal to or smaller than a predetermined target level.

4. The management system according to claim 3, further comprising a request device configured to request the management device to perform the power balancing of the external power supply, wherein:
the external power supply is a power system configured to supply electric power to a predetermined area;
a charging location of each of the vehicles in the predetermined area is registered in the management device;
the management device is configured to receive, from the request device, the second information and a request signal indicating details of the power balancing for each time slot;
the management device is configured to receive the scheduled use start time and the target state of charge set in the charge control device from the vehicle or a mobile terminal carried by a user of the vehicle; and
the planning unit is configured to determine the charge plan of each of the vehicles to achieve a state in which a total charge energy of the power storage devices of the vehicles increases during a time slot in which the request signal requests an increase in power demand, and a state in which the total charge energy of the power storage devices of the vehicles decreases during a time slot in which the request signal requests a decrease in the power demand.

5. The management system according to claim 4, wherein:
the management device further includes a modification unit configured to, in response to a request from the request device, modify the charge plan of each of the vehicles determined by the planning unit; and
the management unit is configured to cause the vehicle with the charge plan unmodified to operate according to the charge plan determined by the planning unit, and cause the vehicle with the charge plan modified by the modification unit to operate according to the modified charge plan.

6. The management system according to claim 2, wherein:
the second information indicates, for each time slot, an amount of carbon dioxide emitted in the process of generating the electric power to be supplied by the external power supply; and
the planning unit is configured to determine the charge plan of each of the vehicles to satisfy a condition that a state of charge of the power storage device in each of the vehicles is equal to or higher than the target state of charge at the scheduled use start time, and to minimize a total value of the amounts of carbon dioxide emitted in the process of generating the electric power to be used in the charge plan of each of the vehicles.

7. The management system according to claim 2, wherein:
the charge control device is configured to set a charge mode in response to an input from a user among a plurality of types of charge mode;
the plurality of types of charge mode includes a first charge mode;
the management unit is configured not to execute charge control for the power balancing of the external power supply on the vehicle for which the first charge mode is set in the charge control device; and
the management unit is configured to select a control target from among the vehicles for which a charge mode other than the first charge mode is set in the charge control device, and cause the selected control target to execute the charge control for the power balancing of the external power supply by transmitting a control command according to the charge plan or a modified charge plan to the control target.

8. The management system according to claim 7, wherein:
the management device further includes a prediction unit configured to execute movement prediction on each of the vehicles;
the plurality of types of charge mode further includes a second charge mode and a third charge mode;
the planning unit is configured to, for the vehicle for which the second charge mode is set in the charge control device, determine the charge plan of the vehicle by using the second information and the scheduled use start time and the target state of charge set in the charge control device by the user; and
the planning unit is configured to, for the vehicle for which the third charge mode is set in the charge control device, set the scheduled use start time and the target state of charge in the charge control device by using a result of the movement prediction, and determine the charge plan of the vehicle by using the set scheduled use start time, the set target state of charge, and the second information.

9. The management system according to claim 2, wherein:
the management unit is configured to select a control target from among the vehicles, and set the charge plan or a modified charge plan in the charge control device of the selected control target; and
the charge control device is configured to execute the charge control on the power storage device according to the set charge plan.

10. A management device configured to manage a plurality of resources configured to be electrically connected to an external power supply, the management device comprising:
a planning unit configured to determine a power balancing plan of each of the resources by using first information on a use schedule of each of the resources and second information indicating a magnitude of an environmental load in a process of generating electric power to be supplied by the external power supply; and
a management unit configured to manage the resources to cause each of the resources to operate according to the power balancing plan or a modified power balancing plan in power balancing of the external power supply.

11. A management device configured to manage a plurality of resources configured to be electrically connected to an external power supply, the management device comprising:
a determination unit configured to determine, for each time slot, a total electric energy to be balanced for the external power supply by the resources by using first information on a use schedule of each of the resources and second information indicating a magnitude of an environmental load in a process of generating electric power to be supplied by the external power supply; and
a transmission unit configured to transmit the total electric energy for the each time slot that has been determined by the determination unit.

12. A power balancing method using the management device according to claim 10, wherein the power balancing method includes:
determining, by the management device, the power balancing plan of each of the resources by using the first information on the use schedule of each of the resources and the second information indicating the magnitude of the environmental load in the process of generating the electric power to be supplied by the external power supply; and
operating, by each of the resources, according to the power balancing plan or a modified power balancing plan in the power balancing of the external power supply.
